(19) United States
(12) Patent Application Publication
(10) Pub. No.: US 2024/0330738 A1
(43) Pub. Date: Oct. 3, 2024

(54) QUANTUM COMPILATION SERVICE

(71) Applicant: Amazon Technologies, Inc., Seattle, WA (US)

(72) Inventors: Yunong Shi, Old Greenwich, CT (US); Ravi Kiran Chilakapati, Mill Creek, WA (US); Jeffrey Paul Heckey, Seattle, WA (US); Jon-Mychael Allen Best, Seattle, WA (US); Eric M Kessler, New Rochelle, NY (US)

(73) Assignee: Amazon Technologies, Inc., Seattle, WA (US)

(21) Appl. No.: 18/193,294

(22) Filed: Mar. 30, 2023

(51) Int. Cl. G06N 10/80

(52) U.S. Cl. CPC G06N 10/80

(57) ABSTRACT

Systems and method for implementing quantum circuit compilation as-a-service are disclosed. In some embodiments, a quantum circuit compilation service is configured to compile quantum circuits for a plurality of third-party customers, wherein the compilation service supports compiling quantum circuits to be executed on a plurality of different quantum processing units that utilize various different quantum computing technologies. In some embodiments, the quantum computing service generates a customized compilation job plan for each quantum circuit to be compiled. The compilation job plan may reference modular compilation passes stored in a repository of the quantum circuit compilation service. The modular passes may be mixed and matched as needed to allow for compilation of a wide-variety of quantum circuits to be executed using various different quantum computing technologies.

### BACKGROUND

Quantum computing utilizes the laws of quantum physics to process information. Quantum physics is a theory that describes the behavior of reality at the fundamental level. It is currently the only physical theory that is capable of consistently predicting the behavior of microscopic quantum objects like photons, molecules, atoms, and electrons.

A quantum computer is a device that utilizes quantum physics to allow one to write, store, process and read out information encoded in quantum states, e.g., the states of quantum objects. A quantum object is a physical object that behaves according to the laws of quantum physics. The state of a physical object is a description of the object at a given time.

In quantum physics, the state of a two-level quantum system, or simply, a qubit, is a list of two complex numbers whose squares sum up to one. Each of the two numbers is called an amplitude, or quasi-probability, and their squared absolute values are probabilities that a measurement of the qubit results in zero or one. A fundamental and counterintuitive difference between a probabilistic bit (e.g., a classical zero or one bit) and the qubit is that a probabilistic bit represents a lack of information about a two-level classical system, while a qubit contains maximal information about a two-level quantum system.

Quantum computers are based on such quantum bits (qubits), which may experience the phenomena of “superposition” and “entanglement.” Superposition allows a quantum system to be in multiple states at the same time. For example, whereas a classical computer is based on bits that are either zero or one, a qubit may be both zero and one at the same time, with different probabilities assigned to zero and one. Entanglement is a strong correlation between quantum systems, such that the quantum systems are inextricably linked even if separated by great distances.

A quantum algorithm comprises a reversible transformation acting on qubits in a desired and controlled way, followed by a measurement on one or multiple qubits. For example, if a system has two qubits, a transformation may modify four numbers; with three qubits this becomes eight numbers, and so on. As such, a quantum algorithm acts on a list of numbers exponentially large as dictated by the number of qubits. To implement a transform, the transform may be decomposed into small operations acting on a single qubit, or a pair of qubits, as an example. Such small operations may be called quantum gates and a specific arrangement of the quantum gates implements a quantum circuit.

There are different types of qubits that may be used in quantum computers, each having different advantages and disadvantages. For example, some quantum computers may include qubits built from superconductors, trapped ions, semiconductors, photonics, etc. Each may experience different levels of interference, errors and decoherence. Also, some may be more useful for generating particular types of quantum circuits or quantum algorithms, while others may be more useful for generating other types of quantum circuits or quantum algorithms. Also, costs, run-times, error rates, availability, etc. may vary across quantum computing technologies.

### BRIEF DESCRIPTION OF THE DRAWINGS

FIG. 1 illustrates a service provider network that enables customers to compile and/or execute quantum circuits using multiple quantum computing technologies, according to some embodiments.

FIG. 2 illustrates additional components that may be included in a quantum circuit compilation service of the service provider network, according to some embodiments.

FIG. 3 illustrates example modular compilation passes that may be included in a modular compilation pass repository of the quantum circuit compilation service, according to some embodiments.

FIG. 4 illustrates an example quantum circuit compilation job plan that may be generated by the quantum circuit compilation service and also illustrates a workflow for orchestrating execution of the quantum circuit compilation job plan in order to at least partially compile a quantum circuit, according to some embodiments.

FIG. 5 illustrates an example quantum circuit compilation process, wherein a client-side compiler outsources one or more compilation passes to be performed by a quantum circuit compilation service, according to some embodiments.

FIG. 6 illustrates an example quantum circuit compilation process, wherein a quantum compilation service provides a client-side compiler a containerized computing object comprising a quantum compilation job plan and modular compilation pass instructions for performing a set of modular compilation passes as indicated in the quantum compilation job plan, according to some embodiments.

FIG. 7 illustrates an example quantum circuit compilation process, wherein a quantum compilation service performs quantum circuit compilation on behalf of a quantum computing service, wherein a customer submits a quantum circuit to be executed to the quantum computing service, the quantum computing service coordinates with the quantum circuit compilation service to compile the quantum circuit, and the quantum computing service executes the quantum circuit using a compiled artifact returned from the quantum circuit compilation service, according to some embodiments.

FIG. 8 illustrates an example quantum circuit compilation process, wherein a customer delegates quantum compilation to a quantum circuit compilation service, the quantum circuit compilation service partially compiles the quantum circuit, the quantum circuit compilation service returns the partially compiled quantum circuit to a client-side compiler, the client-side compiler performs one or more additional compilation passes, the client-side compiler then returns the further partially compiled quantum circuit to the quantum circuit compilation service, the quantum circuit compilation service completes compilation, and a quantum computing service executes the quantum circuit using a compiled artifact generated by the quantum circuit compilation service, according to some embodiments.

FIG. 9 illustrates example quantum circuit compilation processes that invoke a “verbatim” quantum circuit compilation, according to some embodiments.

FIG. 10A illustrates an in-line compilation process, wherein compilation of quantum tasks is performed in-line with execution of the quantum tasks, according to some embodiments.

FIG. 10B illustrates a de-coupled quantum circuit compilation process, as may be performed by a quantum circuit compilation service, wherein compilation is performed in a de-coupled manner from quantum circuit execution, according to some embodiments.

FIG. 11 illustrates an example of a web-based implementation of a user interface of the quantum circuit compilation service, according to some embodiments.

FIG. 12A illustrates an example of a physical qubit connectivity graph for a given quantum hardware device and the generation of corresponding physical qubit and edge lists, according to some embodiments.

FIG. 12B illustrates an example of a logical quantum circuit and the generation of corresponding logical qubit, gate, and gate dependency lists, according to some embodiments.

FIG. 13 illustrates an example modular compilation pass module, for example that may use an SAT solver to generate mappings of logical quantum circuits to quantum hardware devices, according to some embodiments.

FIG. 14 illustrates another example modular compilation pass module, for example that may use a reinforcement-learning-based machine learning model to generate mappings of logical quantum circuits to quantum hardware devices, according to some embodiments.

FIG. 15 illustrates an additional example modular compilation pass module, for example that may use an SMT solver to generate mappings of logical quantum circuits to quantum hardware devices, according to some embodiments.

FIG. 16 illustrates edge computing devices of a quantum computing service physically located at quantum hardware provider locations, according to some embodiments.

FIG. 17 illustrates an example edge computing device connected to a quantum computing service, according to some embodiments.

FIG. 18 illustrates example interactions between a quantum computing service and an edge computing device of the quantum computing service, according to some embodiments.

FIG. 19 is a flowchart illustrating an example process for compiling a quantum circuit, on behalf of a customer, using a cloud-based quantum circuit compilation service, according to some embodiments.

FIG. 20 is a block diagram illustrating an example classical computing device that may be used in at least some embodiments.

While embodiments are described herein by way of example for several embodiments and illustrative drawings, those skilled in the art will recognize that embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to. When used in the claims, the term “or” is used as an inclusive or and not as an exclusive or. For example, the phrase “at least one of x, y, or z” means any one of x, y, and z, as well as any combination thereof.

### DETAILED DESCRIPTION

The present disclosure relates to methods and apparatus for performing quantum circuit compilation-as-a-service. Quantum circuits (and/or other quantum algorithms) are often constructed using logical qubits and logical operators. However, these logical qubits and logical operators need to be mapped and scheduled on real-world physical components of a quantum processing unit in order to execute the quantum circuits using quantum hardware. Also, due to the limited physical qubit count of most quantum hardware devices, efficient mapping and scheduling is required in order to enable the quantum circuit to be executed on the real-world quantum processing unit. Also, not only must the quantum circuit mapping “fit” within the available qubits of the physical quantum hardware device, different quantum circuit mappings that “fit” within the available qubits of the physical quantum hardware device may exhibit different error levels, due to noise, cross-talk, etc. Thus, compilation may take into account not only how to “fit” and “schedule” the logical qubits and logical operators within the limited physical capacity of the quantum hardware device, but may also account for how different mappings and scheduling may impact error rates of execution of the quantum circuit. Said another way, quantum circuit compilation involves generating a hardware specific executable (e.g., a compiled artifact, such as a compiled binary for generating pulse sequences used to implement a quantum circuit on a quantum hardware device) based on a provided abstract quantum algorithm or logical quantum circuit. In some embodiments, the compiled artifact may then be executed on a physical quantum computing device and/or a simulator that simulates a quantum computing device.

In some embodiments, compilation results may be evaluated based on a quantity of quantum gates used in the compilation and/or a circuit depth resulting from the compilation, as a few examples. For example, using fewer quantum gates (especially SWAP gates) reduces complexity of the execution of the compiled quantum circuit and also reduces opportunities for errors to occur during the execution of the compiled quantum circuit. Likewise, reducing circuit depth also reduces complexity and error. In some embodiments, circuit depth may be understood as a number of gates performed on a given physical qubit. For example, if five gates are performed on a physical qubit, the quantum circuit (with regard to that qubit) may be said to have a circuit depth of five. In some embodiments, SWAP gates may be used to swap logical states between physical qubits in order to allow gates to be performed between qubits that do not have a direct physical connectivity. However, minimization of SWAP gates in a compiled quantum circuit is desirable, as swap gates increase circuit depth and gate count, which may introduce opportunities for errors to occur.

In some embodiments, compilation may include two high-level phases, a first compilation phase that generates an optimized qubit allocation and mapping that is specific to a particular quantum processing unit that is to execute a quantum circuit, and a second compilation phase that generates pulse sequences to be used to implement the logical qubits and logical gates on the physical qubits of the particular quantum processing unit. Additionally, the first compilation phase may involve at least three high-level steps: (1) nativization, (2) qubit allocation and gate mapping, and (3) optimization. In some embodiments, optimization steps may be performed throughout the compilation process, such as in between nativization passes or between qubit allocation and/or gate mapping passes, or as another optimization step following qubit allocation and gate mapping.

In some embodiments, quantum circuits to be compiled may initially be formatted in an intermediate representation that represents the elements of the quantum circuit (e.g., qubits and gates) using logical operators that are not specific to any one quantum hardware device or type of quantum hardware devices. This may allow customers to write a single quantum circuit and then execute the single quantum circuit on various different quantum hardware devices, for example that may be provided by different quantum hardware providers, and that may use different quantum computing technologies. In order to compile such quantum circuits represented in an intermediate representation, the logical elements are first translated into native operators that are native to a particular quantum hardware type that is to be used to execute the quantum circuit. Qubit allocation and mapping then uses the nativized quantum circuit to determine how to allocate the logical qubits of the nativized quantum circuit to the physical qubits of the quantum processing unit that is to be used to execute the quantum circuit. Also, mapping involves determining which gates are to be performed between which physical qubits and in what order such that the mapped gates achieve the logic of the nativized quantum circuit. In some embodiments, various optimization solvers, such as SAT solvers, SMT solvers, etc. may be used to determine an optimized mapping.

In some embodiments, nativization may involve decomposing a higher-level abstract quantum gate (or other logical operator) into a set of native gates that achieve the logical result of the higher-level abstract quantum gate when performed in a particular order. In some embodiments, a customer of a quantum compilation service may submit custom gate decompositions that the customer would like to be used in compiling quantum circuits on behalf of the customer. Also, the quantum circuit compilation service may also include its own library of gate decompositions to be used to nativize quantum circuits. In some embodiments, customer submitted custom gate decompositions may be used to augment the quantum circuit compilation service's gate decomposition library.

In some embodiments, customers may request that a quantum circuit compilation service determine a compilation job plan, e.g., determine a list of compilation passes to be performed, wherein the quantum circuit compilation service returns to the customer a software container comprising the quantum circuit job plan and modular compilation pass instructions (e.g., executable code) for performing the compilation passes indicated in the compilation job plan. Alternatively, in some embodiments, the quantum circuit compilation service may both determine the compilation job plan and orchestrate execution of the compilation job plan using computing resources of a service provider network. For example, the service provider network may include computing resources that can be efficiently scaled up, for example in order to perform mapping optimization using a high-powered solver, such as an SAT solver or SMT solver. Also, in some embodiments, performance of compilation passes may be divided between a client-side compiler and a quantum compilation service. For example, a client-side compiler may perform a proprietary compilation process, but may lack the resources to perform high-powered solvers, and therefore may delegate a mapping optimization compilation pass to a quantum compilation service to perform, for example using a SAT solver, SMT solver, etc. As yet another example, a customer may delegate compilation to be performed by a quantum circuit compilation service, but may reserve one or more compilation passes to be performed by the customer's client-side compiler. In such cases, the quantum compilation service may pass a partially compiled quantum circuit to the customer's client-side compiler (for example in an intermediate representation) and then receive an updated version of the partially compiled quantum circuit that includes results from the customer's client-side compiler performing one ore more compilation passes. The quantum compilation service may perform one or more additional compilation passes to complete the compilation and may provide the compiled quantum circuit back to the customer and/or pass the compiled quantum circuit to a quantum computing service configured to orchestrate execution of the compiled quantum circuit for the customer using QPUs of quantum hardware providers and/or a QPU of the quantum computing service.

In some embodiments, optimization compilation passes may be performed throughout the compilation process. Optimization compilation passes may reduce gate count, for example by identifying gates that commute and therefore can be canceled out, reduce swap gates, for example by determining optimized gate scheduling that makes a better use of the qubit connectivities of the quantum hardware. Also, optimization may re-arrange qubit allocations and/or gate scheduling to reduce circuit depth, cross-talk, idle errors, etc. As another example, optimization may merge 1-qubit gates, such as in a series of consecutive 1-qubit gates.

In some embodiments, in a second phase of the compilation process a resulting compiled quantum circuit from the first phase is used to generate a compiled artifact for implementing pulses. For example, a quantum processing unit may include a field programmable gate array (FPGA) or other processor that acts as an interface for instruments of the QPU that emit pulses that entangle qubits and gates on the physical quantum hardware device. The FPGA may execute the compiled artifact, such as a compiled binary, to cause the instruments of the QPU to emit the pulses of the determined pulse sequence. In some embodiments, customers may submit custom pulse sequences that are to be used to implement particular gates, and these custom pulse sequences may be used in generating the compiled artifact for implementing pulses, such as a compiled binary to be executed using an FPGA or ASIC that controls instruments of the quantum hardware device. In some embodiments, a quantum compilation service may further perform optimization when generating the pulse sequencing. For example, efficiencies may be gained by altering an ordering of the pulses.

In some embodiments, customers of a quantum compilation service may desire a “verbatim” compilation and/or execution of a quantum circuit. For example, in order to perform repeatable experiments, customers may desire that compilation be performed without variability from one run to the next. In order to provide for “verbatim” compilation, a customer may provide their own quantum compilation job plan that is to be performed using resources of a quantum compilation service “verbatim” e.g., exactly as laid out in the customer provided quantum compilation job plan. Alternatively, a customer may submit a series of quantum circuits and indicate that “verbatim” compilation is to be performed by the quantum compilation service. In such cases, the quantum compilation service may determine a quantum compilation job plan for the first instance of the series of verbatim quantum circuits and may cache the determined compilation job plan to be used “verbatim” to compile the remaining instances of the series of verbatim quantum circuits. Also, in some embodiments, customers may perform compilation using a client-side compiler in order to generate a compiled artifact that is to be used for “verbatim” execution. In some embodiments, the client-side compiler may outsource one or more passes to a quantum circuit compilation service, as described above.

In some embodiments, a quantum circuit compilation service may provide a centralized and standardized compilation process that allows customers to learn how to compile quantum circuits to be executed on various types of quantum hardware devices and avoids the need for customers to learn the details of varying compilation procedures used by various different quantum hardware providers. For example, a customer may use a quantum compilation service to compile quantum circuits to be run on various different quantum hardware provider QPUs. As described in more detail below, the use of modular compilation passes, may allow a quantum compilation service to be configured to compile various types of quantum circuits to be compiled for various types of quantum hardware devices. Also, the modularity of the modular compilation passes allows for efficient use of resources, for example by scaling up computing resources to perform high-powered optimization while not requiring such a large amount of computing resources to be allocated when performing other modular compilation passes that are less compute intensive.

In some embodiments, a quantum compilation service may also de-couple compilation of a quantum circuit from execution of the quantum circuit. For example, a quantum compilation service may compile quantum circuits outside of a workflow for executing the quantum circuits on QPUs. This may allow for up front compilation. For example, if a quantum algorithm includes various quantum circuits, a quantum compilation service may compile the various quantum circuits up-front prior to execution. This may allow for a more efficient use of an access time window on a QPU. For example, instead of waiting to compile subsequent quantum circuits of the quantum algorithm as they are invoked, the quantum circuits may be compiled ahead of time, and compiled artifacts resulting from the compilation may be run when the respective quantum circuits are to be invoked without waiting for compilation. This may make for a more efficient use of a limited access time window for use of a QPU.

In some embodiments, a quantum compilation service may further utilize machine learning to select modular compilation passes to be included in a compilation job plan and/or to determine an ordering for performing the modular compilation passes.

In some embodiments, a quantum compilation service may further be connected to a quantum hardware information service that collects information from quantum hardware providers, such as qubit connectivity graphs, calibration information, etc. This collected information may be used to compile quantum circuits for execution on the respective quantum hardware providers. Also, the connection to the quantum hardware information service may avoid the need for the customer to provide such information when asking for a given quantum circuit to be compiled by the quantum circuit compilation service.

In some embodiments, a mapping process involves enabling a logical quantum circuit to be executed on a given quantum hardware device according to a quantum hardware device's physical qubit connectivity graph (also referred to as a qubit interaction graph). Such a process may be referred to herein as a quantum circuit mapping. In some embodiments, logical computation that may be required to execute the logical quantum circuit may utilize more physical qubits than are available on the given quantum hardware device, and/or the logical computation may not be conducive to a given configuration of physical qubits and connected edges (also called a physical qubit connectivity graph). For example, a logical computation may assign for a gate to be performed between two physical qubits on a quantum hardware device which are not physically connected via an edge. In such cases, a “SWAP operation” (e.g., a SWAP gate) may be used to logically exchange the quantum states between two respective physical qubits, allowing for a circumvention of some physical limitations of the given quantum hardware device.

While SWAP operations (e.g., a SWAP gate) may extend the capability of a given quantum hardware device for executing logical operations by allowing for certain qubit states to be logically re-mapped, such SWAP operations may increase a duration of time required to execute a given logical quantum circuit. For example, a SWAP gate may comprise three CNOT gates, which adds time to a total execution time of a logical quantum circuit. Furthermore, the three CNOT gates may introduce additional error and/or noise (e.g., crosstalk), and may therefore introduce additional difficulty in error correction of the quantum circuit. Therefore, it is beneficial to minimize a number of SWAP operations (e.g., SWAP gates) that are implemented in a given quantum circuit mapping.

Solving for (e.g., generating an assignment wherein a given logical quantum circuit may be mapped to a physical qubit layout of a given quantum hardware device and executed using the quantum hardware device) and optimizing (e.g., minimizing a number of SWAP gates) a given quantum circuit mapping problem may be considered as an NP-hard (also referred to as NP-complete) optimization problem.

### Example Quantum Computing Service

Quantum computers may be difficult and costly to construct and operate. Also, there are varying quantum computing technologies under development with no clear trend as to which of the developing quantum computing technologies may gain prominence. Thus, potential users of quantum computers may be hesitant to invest in building or acquiring a particular type of quantum computer, as other quantum computing technologies may eclipse a selected quantum computing technology that a potential quantum computer user may invest in. Also, successfully using quantum computers to solve practical problems may require significant trial and error and/or otherwise require significant expertise in using quantum computers.

As an alternative to building and maintaining a quantum computer, potential users of quantum computers may instead prefer to rely on a quantum computing service to provide access to quantum computers. Also, in some embodiments, a quantum computing service, as described herein, may enable potential users of quantum computers to access quantum computers based on multiple different quantum computing technologies and/or paradigms, without the cost and resources required to build or manage such quantum computers. Also, in some embodiments, a quantum computing service, as described herein, may provide various services that simplify the experience of using a quantum computer such that potential quantum computer users lacking deep experience or knowledge of quantum mechanics, may, never the less, utilize quantum computing services to solve problems.

Also, in some embodiments, a quantum computing service, as described herein, may be used to supplement other services offered by a service provider network. For example, a quantum computing service may interact with a classical computing service to execute hybrid algorithms. In some embodiments, a quantum computing service may allow a classical computer to be accelerated by sending particular tasks to a quantum computer for execution, and then further performing additional classical compute operations using the results of the execution of a quantum computing object on the quantum computer. For example, a quantum computing service may allow for the acceleration of virtual machines implemented on classical hardware in a similar manner as a graphics processing unit (GPU) may accelerate graphical operations that otherwise would be performed on a central processing unit (CPU). A quantum computing service may also interact with other services offered by a service provider network such as a compilation service described above.

In some embodiments, a quantum computing service may provide potential quantum computer users with access to quantum computers using various quantum computing technologies, such as quantum annealers, ion trap machines, superconducting machines, Rydberg atom arrays, photonic devices, etc. In some embodiments, a quantum computing service may provide customers with access to at least three broad categories of quantum computers including quantum annealers, circuit-based quantum computers, and analog or continuous variable quantum computers. As used herein, these three broad categories may be referred to as quantum computing paradigms.

In some embodiments, a quantum computing service may be configured to provide simulation services using classical hardware-based computing instances to simulate execution of a quantum circuit on a quantum computer. In some embodiments, a quantum computing service may be configured to perform general simulation and/or simulation that specifically simulates execution of a quantum circuit on a particular type of quantum computer of a particular quantum computer technology type or paradigm type. In some embodiments, simulation may be fully managed by a quantum computing service on behalf of a customer of the quantum computing service. For example, the quantum computing service may reserve sufficient computing capacity on a virtualized computing service of the service provider network to perform simulation without customer involvement in the details of managing the resources for the simulator.

In some embodiments, a quantum computing service may include a dedicated console that provides customers access to multiple quantum computing technologies. Furthermore, the quantum computing service may provide a quantum algorithm development kit that enables customers with varying levels of familiarity with quantum circuit design to design and execute quantum circuits. In some embodiments, a console of a quantum computing service may include various application programmatic interfaces (APIs), such as:
(Create/Delete/Update/Get/List)Simulator-Configuration-create, read, update, and delete (CRUD) operations for simulator configuration objects.
(Start/Cancel/Describe)Simulator-used to control each of the user-defined simulator instances.
(List/Describe) quantum processor units (QPUs)-retrieves quantum computer hardware information.
(Create/Cancel/List/Describe)Job-used to manage the lifecycle of a quantum job.
(Assign/Update/List) Quality of Service (QOS) guarantee-used to manage QoS guarantees for quantum jobs and/or quantum tasks.
(Create/Cancel/List/Describe)Task-used to manage the lifecycle of individual quantum tasks/quantum objects.

In some embodiments, a quantum algorithm development kit may include a graphical user interface, APIs or other interface to allow customers of a quantum computing service to define quantum objects, such as quantum tasks, algorithms or circuits, using the quantum algorithm development kit. In some embodiments, the quantum algorithm development kit may include an interface option that enables customers to share the quantum objects with other customers of the quantum computing service. For example, the quantum algorithm development kit may include a marketplace that allows customers to share or sell particular quantum objects with other customers. In some embodiments, the quantum algorithm development kit may include an interface element that allows customers to select a QoS to be applied for a quantum job or quantum tasks defined via the quantum algorithm development kit. Also, in some embodiments, the quantum algorithm development kit (or other SDK) may enable a customer to define parameter for compilation and/or build a compilation job plan.

In some embodiments, a quantum computing service may include a public application programmatic interface (API) that accepts quantum objects submitted by a customer of the quantum computing service. In some embodiments, the quantum computing service may accept via the public API, or another API, instructions regarding a QoS guarantee to be used for one or more quantum jobs or quantum tasks, such as executing the quantum object received via the public API. Additionally, the quantum computing service may include a back-end API transport that is non-public. The back-end API transport may enable quantum circuits to be transported from a centralized location that implements the quantum computing service, such as one or more data centers of a service provider network, to an edge computing device at a particular quantum hardware provider location where the quantum circuit is to be executed. In some embodiments, quantum objects or quantum tasks may be executed using an internal QPU of the quantum computing service without using a back-end API transport to transport the quantum job or quantum task to an external quantum hardware provider location.

In some embodiments, results of the execution of a quantum circuit on a quantum computer at a quantum hardware provider location may be provided to the edge computing device at the quantum hardware provider location. The edge computing device may automatically transport the results to a secure storage service of the service provider network, where the customer can access the results using the storage service of the service provider network or via a console of the quantum computing service. Likewise, results of execution of a quantum circuit via an internal QPU may be accessed via the console of the quantum computing service.

In some embodiments, the results stored to the secure storage service may be seamlessly used by other services integrated into the service provider network, such as a machine learning service, a database service, an object-based storage service, a block-storage service, a data presentation service (that reformats the results into a more usable configuration), etc. For example, in some embodiments, a machine learning service may be used to optimize a quantum algorithm or quantum circuit. For example, the machine learning service may cause various versions of a quantum algorithm or quantum circuit to be run on a quantum computer via a quantum computing service. The machine learning service may also be provided access to results of running the quantum algorithms or quantum circuits. In some embodiments, the machine learning service may cause the quantum algorithms or quantum circuits to be run on various different quantum computing technology-based quantum computers. Based on the results, the machine learning service may determine one or more optimizations to improve the quantum algorithms or quantum circuits.

In some embodiments, a quantum computing service may support creating snapshots of results of executing a quantum circuit. For example, the quantum computing service may store snapshots of intermediate results of a hybrid algorithm or may more generally store snapshots of any results generated by executing a quantum circuit on a quantum computer. In some embodiments, an edge computing device at a hardware provider location may temporarily store results and may create snapshot copies of results stored on the edge computing device. The edge computing device may further cause the snapshot copies to be stored in an object-based data storage service of the service provider network. In some embodiments, snapshotting may not be performed, based on customer preferences.

Furthermore, as related to the description herein, it may be understood that quantum hardware, such as quantum hardware device(s), may be used to implement quantum computers, and/or various components of quantum computers (e.g., quantum processing units/cores (QPUs), routing spaces, magic state distillation factories, other components used to perform logical quantum computations, etc.). For example, a given quantum hardware device may resemble “building blocks” of a quantum computer, such as a grid (e.g., a one-dimensional grid, a two-dimensional grid, etc.) of qubits that may be initialized in various ways in order to form various components of a quantum computer, such as topological quantum codes. Quantum hardware devices may be further configured such that single qubit gates, multi-qubit gates, and/or other operations of quantum circuits may be performed between qubits of the quantum hardware devices (according to a given physical qubit connectivity graph of the quantum hardware device which details which physical qubits are connected to respective other physical qubits via edges). A person having ordinary skill in the art should also understand that, depending upon factors such as type(s) of qubit technologies used, type(s) of gates performed between said qubits, etc., quantum hardware devices may also comprise various control devices (e.g., function generators, devices for temperature, magnetic, and/or other environmental controls pertaining to local environments of the grid of qubits, etc.) that may be used to maintain and/or transform various properties of the qubits and/or other physical components of a given quantum computer. Moreover, a person having ordinary skill in the art should understand that a qubit may refer to both a logical bit (e.g., a one or a zero with some probability) and to one or more physical components used to construct the given qubit based, at least in part, on the type of qubit technology being applied. For example, a superconducting qubit (e.g., a transmon) may be constructed using at least a superconducting material and a non-superconducting material in which the non-superconducting material is located in between sections of superconducting material. With regard to this understanding, it should also be understood that quantum hardware may therefore be used to implement physical qubits, in ways such as those as described above, that may again be combined in various ways to implement one or more logical qubits such that logical quantum operations may be performed using said physical elements of said quantum hardware.

### Example Services and Interactions of a Service Provider Network

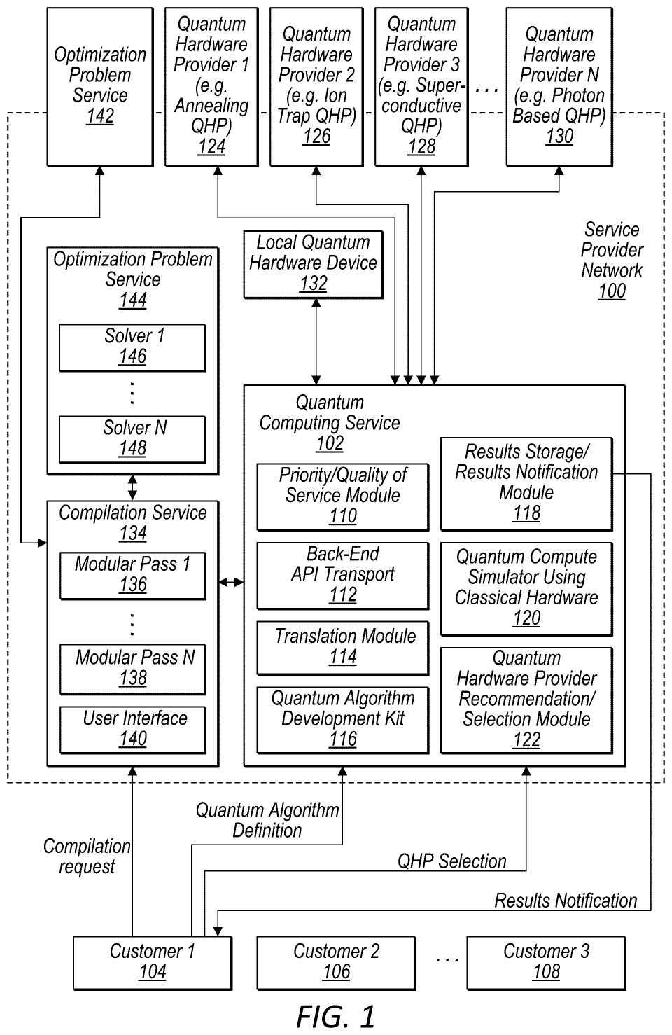

FIG. 1 illustrates a service provider network that enables customers to compile and/or execute quantum circuits using multiple quantum computing technologies, according to some embodiments.

In some embodiments, service provider network 100 may include various services such as quantum computing service 102, compilation service 134, and optimization problem service 144, in addition to one or more other services that pertain to quantum compilation and computation. In some embodiments, service provider network 100 may include data centers, routers, networking devices, etc., such as of a cloud computing provider network. In some embodiments, customers 104, 106, and 108 and/or additional customers of service provider network 100 and/or quantum computing service 102, may be connected to the service provider network 100 in various ways, such as via a logically isolated connection over a public network, via a dedicated private physical connection, not accessible to the public, via a public Internet connection, etc.

In some embodiments, service provider network 100 may include compilation service 134. Compilation service 134 may orchestrate one or more compilation passes (e.g., a compilation mapping of a logical quantum circuit to a given quantum hardware device structure, a compilation of gate nativization(s), translation of a quantum circuit into a quantum circuit specific to a given quantum hardware provider's design/language/architecture/technology, etc.) that may be used in order to take an input logical quantum circuit and conduct, via quantum computing service 102, the execution of said circuit using a given quantum hardware device of a given quantum hardware provider. Customers of service provider network 100 (e.g., customers 104, 106, 108, etc.) may interact with compilation service 134 in order to submit compilation requests, according to some embodiments. Also, the compilation service 134 may return the compiled quantum circuit to the customer, for example instead of directly providing the compiled quantum circuit to the quantum computing service 102 for execution, in some circumstances, based on customer preferences.

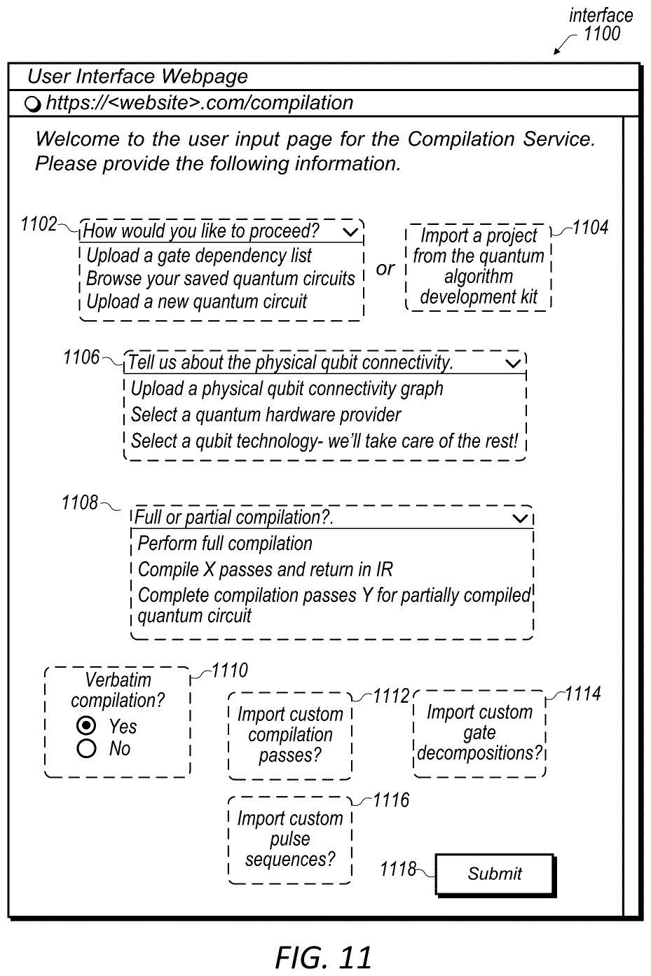

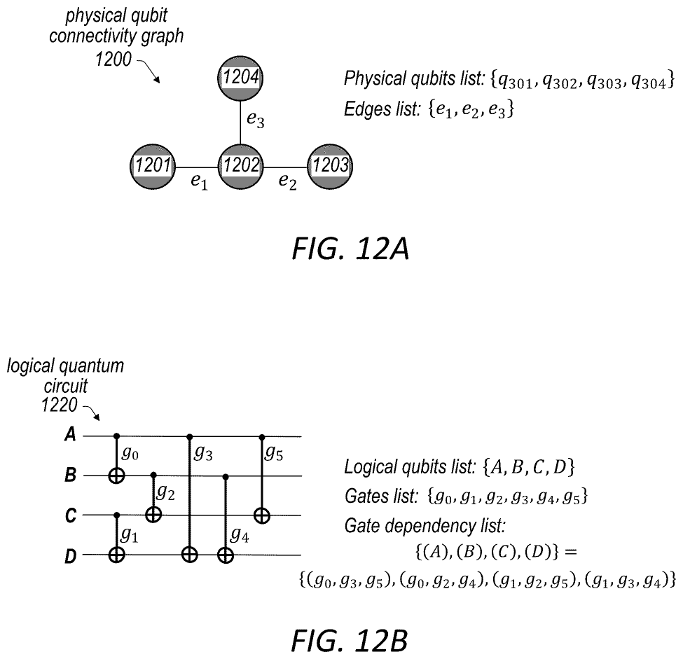

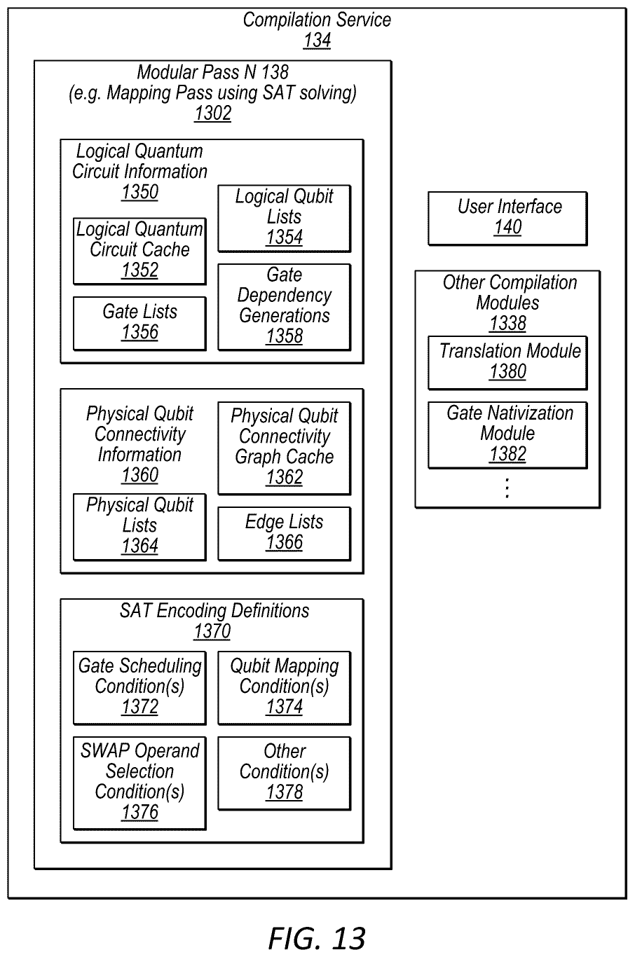

In some embodiments, the modular passes of the compilation service may perform various steps in the compilation process. For example, mapping module 136 may be used to encode a quantum circuit mapping as an optimization problem, such as an SAT solver problem. Logical quantum circuit information and physical qubit connectivity information may be used to receive and store inputs and information pertaining to quantum circuit mappings generated via compilation service 134, according to some embodiments. Such inputs may be submitted via user interface 140 (see description pertaining to interface 1100, shown in FIG. 11 herein). For example, logical quantum circuit cache 1352 (as shown in FIG. 13) may be configured to store logical quantum circuits of one or more customers of compilation service 134, and logical qubit lists 1354 and gate lists 1356 may be configured to store lists of logical qubits and gates that correspond to respective logical quantum circuits (see also description with regard to FIG. 12B herein). In order to encode a quantum circuit mapping problem as an SAT solver problem, a gate dependency list may be generated, based on a given logical quantum circuit stored in logical quantum circuit cache 1352, as part of said encoding process, according to some embodiments. Such gate dependency generations may be stored in gate dependency generations 1358, according to some embodiments. In another example, physical qubit connectivity graph cache 1362 may be configured to store physical qubit connectivity graphs (e.g., physical qubit connectivity graph 1200, shown in FIG. 12A) of one or more quantum hardware devices of quantum hardware providers (e.g., quantum hardware providers 124, 126, 128, 130) and/or physical qubit connectivity graphs provided by customers of compilation service 134. Physical qubit lists 1364 and edge lists 1366 may be configured to store lists of physical qubits and edges that correspond to respective physical qubit connectivity graphs. In some embodiments, in order to encode a quantum circuit mapping problem as an SAT solver problem, a physical qubit and edge lists may be generated, based on a given physical qubit connectivity graph stored in physical qubit connectivity graph cache 1362, as part of said encoding process.

In some embodiments, compilation service 134 be configured to use information in logical quantum circuit information 1350 and physical qubit connectivity information 1360, and a layout-transition-based order encoding scheme defined via SAT encoding definitions 1370 in order to generate a CNF equation that represents a given quantum circuit mapping problem. SAT encoding definitions 1370 may include one or more conditions, constraints, and/or other definitions used to encode quantum circuit mapping problems as SAT solver problems, such as gate scheduling condition(s) 1372, qubit mapping condition(s) 1374, SWAP operand selection condition(s) 1376, and/or other condition(s) 1378, according to some embodiments.

An encoded SAT solver problem may then be provided by compilation service 134 to an optimization problem service (e.g., optimization problem service 142, optimization problem service 144, etc.) such that the encoded SAT solver problem may be executed using a SAT solver (e.g., a SAT solver invoked by modular pass 1302). In some embodiments, an optimization problem service may be configured to implement SAT solving instances, in addition to instances of other optimization problem solving techniques (e.g., SMT solving, heuristic solving approaches, etc.).

Compilation service 134 may also orchestrate and/or coordinate the execution of the encoded SAT solver problem. For example, compilation service 134 may request certain compute resources, a time allocation, etc. in order to enable the execution of the encoded SAT solver problem using an optimization problem service. In some embodiments, compilation service 134 may communicate with optimization problem service 144 within service provider network 100 in order to coordinate the execution of a given encoded SAT solver problem using a SAT solving instance of SAT solver 146. In some embodiments, compilation service 134 may be configured to communicate with one or more other optimization problem services accessible via service provider network 100, such as optimization problem service 142, in which the optimization problem service may be located at a premises outside of service provider network 100. In such embodiments, compilation service 134 may communicate with optimization problem service 142 via an edge computing device physically located at a premises of optimization problem service 142 such that service provider network 100 may be extended. In some embodiments in which multiple encoded SAT solver problems are submitted for execution using SAT solving techniques, compilation service 134 may be further configured to coordinate the execution of said problems using multiple optimization problem services in order to conduct said executions more efficiently.

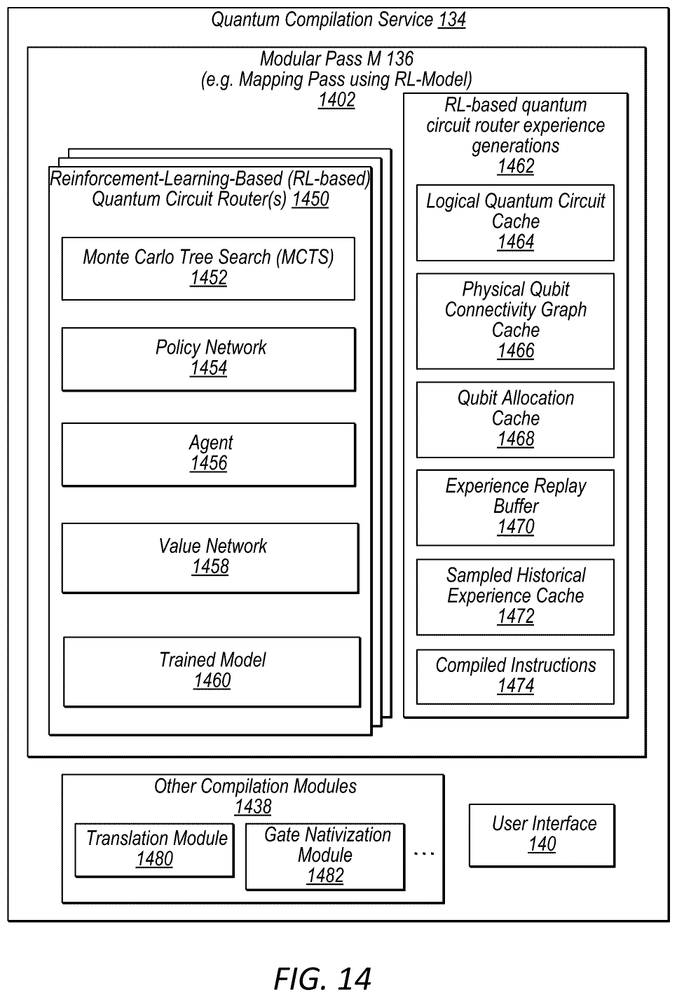

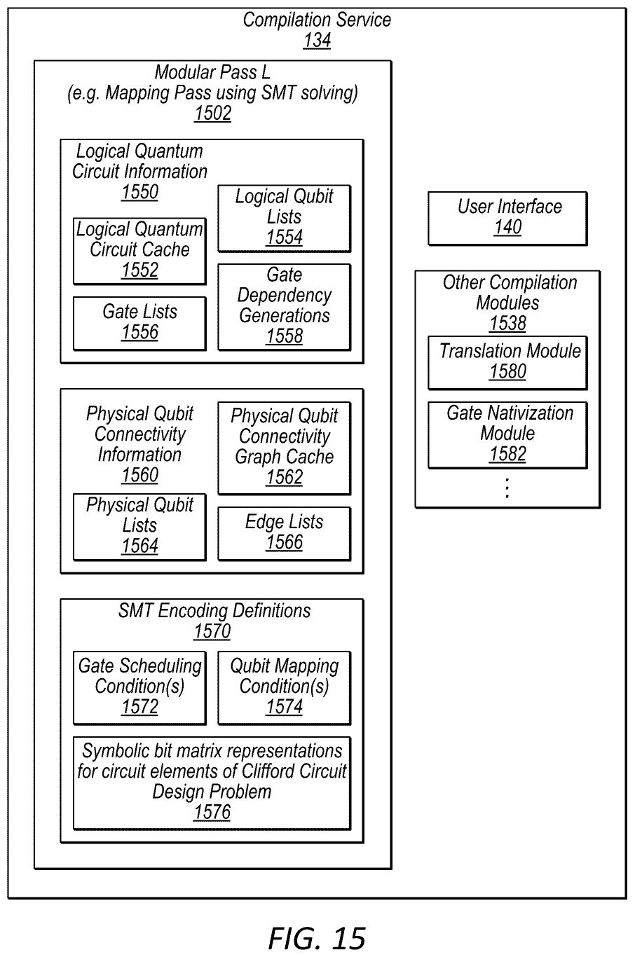

Note that the above example is specific to SAT solving, but in some embodiments, modular passes 136 through 138 of compilation service 134 may utilize other mapping paradigms, such as using a reinforcement-learning-based trained model as described in FIG. 14, SMT solving as described in FIG. 15, or various other mapping processes.

Compilation service 134 may also include one or more additional modules (e.g., other compilation modules 1338, 1438, 1538, etc.). For example, a translation module may be configured to translate non-Clifford operations of a logical quantum circuit into a series of Clifford operations, and/or be configured to perform one or more other intermediate translations pertaining to a target quantum hardware provider. In another example, some two-qubit gates of a logical quantum circuit may be decomposed into a series of native gates, and a gate nativization module may be configured to perform such decompositions. In yet another example, in some embodiments in which a quantum hardware provider of quantum hardware providers 124-130 pertains to Rydberg atom arrays, other compilation modules (e.g., 1338, 1438, 1538, etc.) may include a module configured to compile and/or encode a mapping problem for determining atomic computational positions in Rydberg atom arrays, according to some embodiments.

Service provider network 100 also includes quantum computing service 102. In some embodiments, a quantum computing service 102 may include a quality of service (QoS) and out-of-band prioritization module 110, a quantum algorithm development kit 116, a translation module 114, and a quantum compute simulator using classical hardware 120. Also, quantum computing service 102 is connected to quantum hardware providers 124, 126, 128, and 130. In some embodiments, quantum hardware providers 124, 126, 128, and 130 may offer access to run quantum objects on quantum computers that operate based on various different types of quantum computing technologies or paradigms, such as based on quantum annealing, ion-trap, superconductive materials, photons, etc.

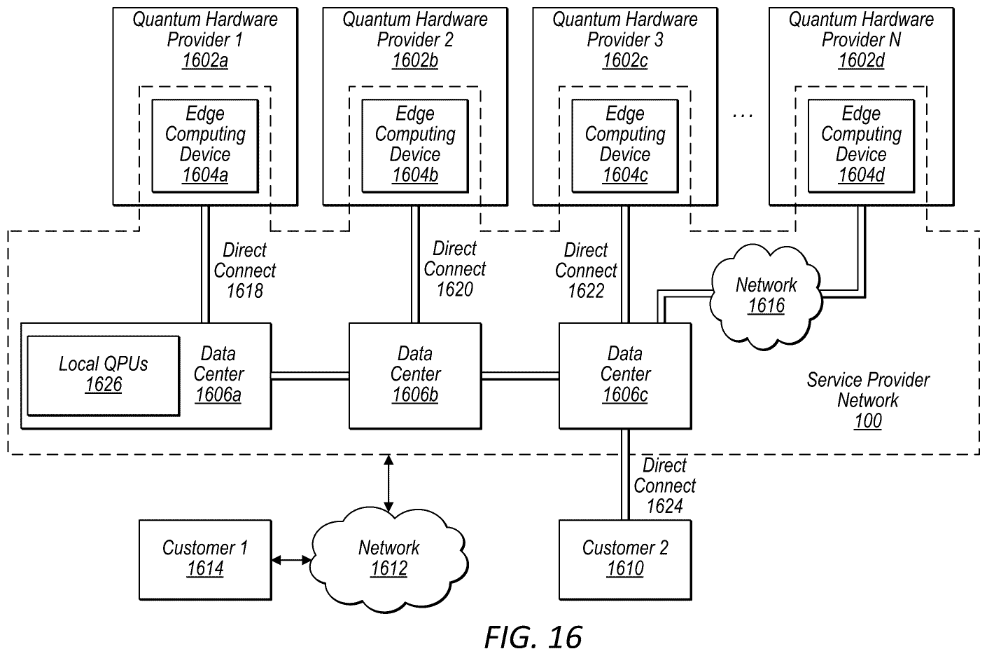

As discussed in additional detail in FIG. 16, in some embodiments, a service provider network 100 may be extended to include one or more edge computing devices physically located at quantum hardware provider locations, such as in a facility of quantum hardware providers 124, 126, 128, and 130. Physically locating (e.g., co-locating) an edge computing device of a service provider network 100 on premises at a quantum hardware provider facility may extend data security and encryption of the service provider network 100 into the quantum hardware providers 124, 126, 128, and 130 facilities, thus ensuring the security of customer data. Also, physically locating an edge computing device of a service provider network 100 on premises at a quantum hardware provider facility may reduce latency between a compute instance of the service provider network and a quantum computer located at the quantum hardware provider facility. Thus, some applications, such as hybrid algorithms that are sensitive to network latencies may be performed by quantum computing service 102, whereas other systems without co-located classical compute capacity at a hardware provider location may have too high of latencies to perform such hybrid algorithms efficiently.

In some embodiments, quantum computing service 102 includes one or more back-end API transport modules 112. In some embodiments, a back-end API transport module 110 may be primarily implemented on edge computing devices of the quantum computing service that are located at the quantum hardware provider locations (such as edge computing devices 1604a, 1604b, 1604c, and 1604d illustrated in FIG. 16). Also, in some embodiments, at least some of the back-end API transport functionality may be implemented on the one or more computing devices of the service provider network that implement the quantum computing service (such as computing devices in data center 1606a, 1606b, 1606c illustrated in FIG. 16). In some embodiments, different quantum hardware providers may require different back-end API transport modules, which may further add variability to execution durations of quantum tasks. Some quantum hardware providers may accept quantum tasks over a network via an API such that it is not necessary for the provider network to locate an edge computing device at the quantum hardware provider's facility in order to submit quantum tasks. In some embodiments, some quantum hardware providers may follow a first in first out (FIFO) execution model for quantum tasks submitted for execution to the quantum hardware provider. Other quantum hardware providers may follow a batch execution model. In order to deal with these execution duration variabilities and to further deal with execution duration variability due to characteristics of various quantum tasks (e.g. number of shots, quantum circuit size, number of gates, time to switch between quantum circuits, etc.), a priority access control plane may order quantum tasks submitted to the back-end API transports for various quantum hardware providers in a prioritized order such that quality of service (Qos) guarantees and other scheduling rules are followed.

Quantum computing service 102 is also configured to translate a given quantum computing object into a selected quantum circuit format for a particular quantum computing technology used by the selected quantum hardware provider or internal QPU, wherein the selected quantum circuit format for the particular quantum computing technology is one of a plurality of quantum circuit formats for a plurality of different quantum computing technologies supported by the quantum computing service. To translate the quantum computing object into the selected quantum circuit format, the one or more computing devices that implement the quantum computing service are configured to identify portions of the quantum computing object corresponding to quantum operators in an intermediate representation in which the quantum object was submitted by the customer, substitute the quantum operators of the intermediate representation with quantum operators of the quantum circuit format of the particular quantum computing technology, and perform one or more optimizations to reduce an overall number of quantum operators in a translated quantum circuit that is a translated version of the received quantum computing object. Additionally, quantum computing service 102 may be configured to provide the translated quantum circuit for execution at a quantum hardware provider or internal QPU that uses the particular quantum computing technology; receive, from the quantum hardware provider or internal QPU, results of the execution of the translated quantum circuit; and provide a notification to a customer of the quantum computing service that the quantum computing object has been executed.

Quantum circuits that have been translated by translation module 114 may be provided to back-end API transport module 112 in order for the translated quantum circuits to be transported to a quantum computer at a respective quantum hardware provider location. In some embodiments, back-end API transport 112 may be a non-public API that is accessible by an edge computing device of service provider network 100, but that is not publicly available. In some embodiments, a quality of service (QOS) and out-of-band prioritization module 110 may manage which quantum tasks are submitted to the back-end API transport and in what order. In some embodiments, edge computing devices at the quantum hardware providers 124, 126, 128, and 130 may periodically ping a quantum computer service side interface to the back-end API transport 112 to determine if there are any quantum circuits (or batches of quantum circuits) waiting to be transported to the edge computing device. If so, the edge computing device may perform an API call to the back-end API transport 112 to cause the quantum circuit to be transported over a private connection to the edge computing device and scheduled for execution on a quantum computer. Also, the edge computing device may have been configured with a quantum machine image that enables the edge computing device to interface with a scheduling application of the quantum hardware provider, where the edge computing device is located, in order to schedule a time slot on the quantum computer of the quantum hardware provider to execute the quantum circuit via the back-end API transport 112.

In some embodiments, results of executing the quantum circuit on the quantum computer at the quantum hardware provider location may be returned to the edge computing device at the quantum hardware provider location. The edge computing device and/or quantum computing service 102 may cause the results to be stored in a data storage system of the service provider network 100. In some embodiments, results storage/results notification module 118 may coordinate storing results and may notify a customer, such as customer 104, that the results are ready from the execution of the customer's quantum object, such as a quantum task, quantum algorithm, or quantum circuit. In some embodiments, results storage/results notification module 118 may cause storage space in a data storage service to be allocated to a customer to store the customer's results. Also, the results storage/results notification module 118 may specify access restrictions for viewing the customer's results in accordance with customer preferences.

In some embodiments, quantum compute simulator using classical hardware 120 of quantum computing service 102 may be used to simulate a quantum algorithm or quantum circuit using classical hardware. For example, one or more virtual machines of a virtual computing service may be instantiated to process a quantum algorithm or quantum circuit simulation job. In some embodiments, quantum compute simulator using classical hardware 120 may fully manage compute instances that perform quantum circuit simulation. For example, in some embodiments, a customer may submit a quantum circuit to be simulated and quantum compute simulator using classical hardware 120 may determine resources needed to perform the simulation job, reserve the resources, configure the resources, etc. In some embodiments, quantum compute simulator using classical hardware 120 may include one or more “warm” simulators that are pre-configured simulators such that they are ready to perform a simulation job without a delay typically involved in reserving resources and configuring the resources to perform simulation.

In some embodiments, quantum computing service 102 includes quantum hardware provider recommendation/selection module 122. In some embodiments, quantum hardware recommendation/selection module 122 may make a recommendation to a quantum computing service customer as to which type of quantum computer or which quantum hardware provider to use to execute a quantum object submitted by the customer. Additionally, or alternatively, the quantum hardware provider recommendation/selection module 122 may receive a customer selection of a quantum computer type and/or quantum hardware provider to use to execute the customer's quantum object, such as a quantum task, quantum algorithm, quantum circuit, etc. submitted by the customer or otherwise defined with customer input. In some embodiments, the recommendation may include estimated costs, error rates, run-times, etc. associated with executing the quantum computing object on quantum computers of respective ones of the quantum hardware providers or an internal QPU.

In some embodiments, a recommendation provided by quantum hardware provider recommendation/selection module 122 may be based on one or more characteristics of a quantum object submitted by a customer and one or more characteristics of the quantum hardware providers supported by the quantum computing service 102, such as one or more of quantum hardware providers 124, 126, 128, or 130.

In some embodiments, quantum hardware provider recommendation/selection module may make a recommendation based on known data about previously executed quantum objects similar to the quantum object submitted by the customer. For example, quantum computing service 102 may store certain amounts of metadata about executed quantum objects and use such metadata to make recommendations. In some embodiments, a recommendation may include an estimated cost to perform the quantum computing task by each of the first and second quantum hardware providers. In some embodiments, a recommendation may include an estimated error rate for each of the first and second quantum hardware providers in regard to performing the quantum computing task. In some embodiments, a recommendation may include an estimated length of time to execute the quantum computing task for each of the first and second quantum hardware providers. In some embodiments, a recommendation may include various other types of information relating to one or more quantum hardware providers or any combination of the above.

In some embodiments, quantum compute simulator using classical hardware 120 may allow a customer to simulate one or more particular quantum computing technology environments. For example, a customer may simulate a quantum circuit in an annealing quantum computing environment and an ion trap quantum computing environment to determine simulated error rates. The customer may then use this information to make a selection of a quantum hardware provider to use to execute the customer's quantum circuit.

### Quantum Compilation-As-A-Service

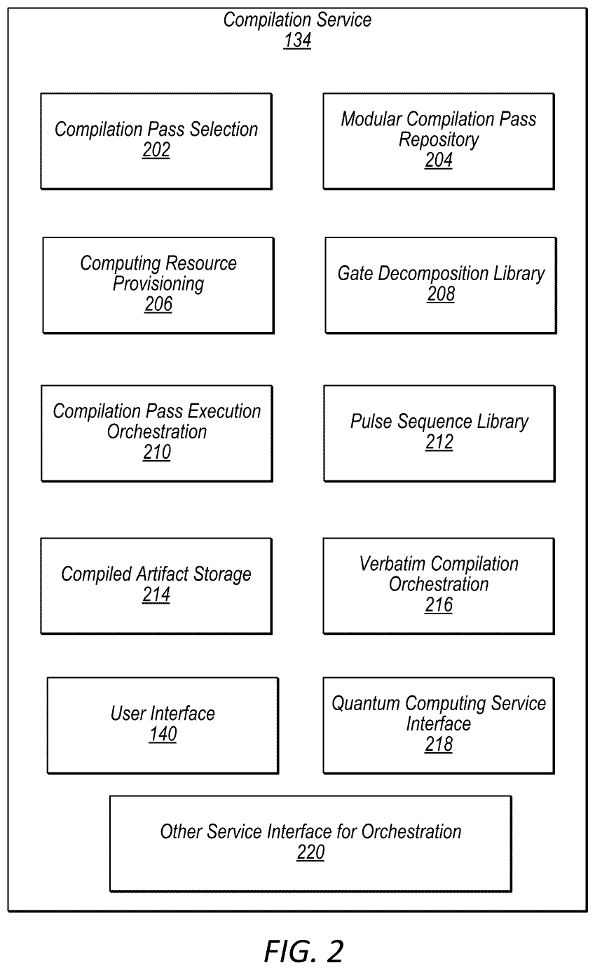

The following figures (FIGS. 2-10B) provide example embodiments of how compilation service 134 may be used to compile quantum circuits on behalf of customers for execution using various types of quantum hardware devices, according to some embodiments.

FIG. 2 illustrates additional components that may be included in a quantum circuit compilation service of a service provider network, such as quantum circuit compilation service 134 of service provider network 100, according to some embodiments.

In some embodiments, a quantum compilation service, such as compilation service 134, may include pass selection 202, modular compilation pass repository 204, computing resource provisioning 206, gate decomposition library 208, compilation pass execution orchestration 210, pulse sequence library 212, compiled artifact storage 214, verbatim compilation orchestration 216, user interface 140, quantum computing service interface 218, and other service interface for orchestration 220.

In some embodiments, modular compilation pass repository 204 may include various compilation pass modules for performing different steps of compilation, such as qubit allocation, gate mapping, optimization, pulse sequence generation, etc. Compilation pass selection module 202 may select a set of the available modular compilation passes to be included in a quantum compilation job. For example, a given one of the qubit allocation pass modules may be selected, along with one or more optimization pass modules. Also, a given mapping module may be selected from a set of supported mapping compilation pass modules, such as an SAT solver-based mapping module (as shown in FIG. 13), a machine learning-based mapping module (as shown in FIG. 14), an SMT-solver based mapping module (as shown in FIG. 15), etc. In some embodiments, compilation pass selection 202 may be performed according to customer preferences submitted via user interface 140. Also, in some embodiments, a machine learning model may be used by compilation pass selection module 202 to select compilation passes to include in a quantum compilation job for a given quantum circuit and/or to determine an order or sequencing of the selected compilation passes. Furthermore, in some embodiments, multiple passes from different ones of the sets may be selected for inclusion in a quantum compilation job plan. For example, multiple optimization passes may be performed back-to-back and/or between respective ones of the other passes. Also, in some embodiments, passes may not be selected from each type of set. For example, a customer may provide a partially compiled quantum circuit, wherein qubit allocation has already been performed, and may ask the quantum circuit compilation service to perform gate mapping using a higher-powered solver, such as an SAT solver or an SMT solver. In such a scenario, a quantum compilation job plan may omit qubit allocation passes and/or may apply optimization passes to the initially provided qubit allocation to determine an improved qubit allocation. The quantum circuit job plan may then include passes for performing the gate mapping, such as modular passes that invoke a higher-powered solver, such as the SAT solver or SMT solver.

Computing resource provisioning 206 may provision (and scale up or down provisioned) computing resources needed to perform respective compilation passes using quantum compilation modules from the modular compilation pass repository 204. For example, virtual computing resources may be allocated from a virtualized computing service of service provider network 100 in order to execute compilation instructions included in respective ones of the modular compilation pass modules. In some embodiments, the compilation pass execution orchestration module 210 may provide performance of workflow management tasks, such as loading a provisioned computing resource with instructions to perform a given modular quantum compilation pass, providing an input representation of the quantum circuit to be compiled to the modular quantum compilation pass, and/or coordinating the storage or forwarding of a resulting version of the quantum circuit after being at least partially compiled by the modular compilation pass. For example, the compilation pass execution orchestration module 210 may route the partially compiled quantum circuit to a next modular compilation pass implemented on another provisioned computing resource. Also, as further described below, in some embodiments, a partially compiled quantum circuit may be routed to a client-side compiler, wherein the client-side compiler performs one or more compilation passes and then returns a further compiled version of the quantum circuit back to the compilation service 134 for further compilation.

In some embodiments, the intermediate or finally compiled versions of the quantum circuit to be compiled may be stored in compiled artifact storage 214. In some embodiments, a compiled artifact representing a compiled quantum circuit may be provided back to the customer, via user interface 140, for example for execution on the customer's quantum computer or on a quantum computer of a third-party. In some embodiments, a compiled artifact may be provided as a compiled circuit representation, wherein the compiled circuit representation represents a compiled version of the quantum circuit that has been compiled specifically for execution on a given QPU. Also, in some embodiments, the compiled artifact may be compiled down to pulse sequences that are to be used to implement the quantum circuit on the given QPU. Additionally, in some embodiments the compiled artifact may comprise compiled pulse sequences that have been compiled into a compiled binary to be executed on a processor of the quantum hardware device, such as an associated FPGA or ASIC.

In some embodiments, the compiled artifact may be provided to a quantum computing service, such as quantum computing service 102, for execution via QPUs of the quantum computing service or via QPUs of third-party quantum hardware providers (QHPs) associated with the quantum computing service. For example, quantum computing service interface 218 may be used to provide the compiled artifact to quantum computing service 102. In some embodiments, computing resource provisioning 206 may use other service interface for orchestration 220 in order to reserve computing resources needed to perform a given modular compilation pass. Also, compilation pass execution orchestration 210 may coordinate with other services to perform certain aspects of a modular compilation pass. For example, other service interface for orchestration 220 may be used to invoke solver 146 or solver 148 of optimization problem service 144, for example as part of performing a mapping compilation pass.

In some embodiments, customers may also submit custom passes, custom gate decompositions, and/or custom pulse sequences to be used when compiling the customer's quantum circuits. These custom objects may be stored in gate decomposition library 208, pulse sequence library 212, and/or modular compilation pass repository 204, and may augment respective gate decompositions, pulse sequences, and modular passes already stored in the respective libraries and repository.

In some embodiments, verbatim compilation orchestration may cause a quantum circuit compilation job plan to be cached, such that subsequently received quantum circuits that invoke the same verbatim compilation are compiled according to a consistent job plan. This may reduce variability in compilation, for example for customers that are performing experiments.

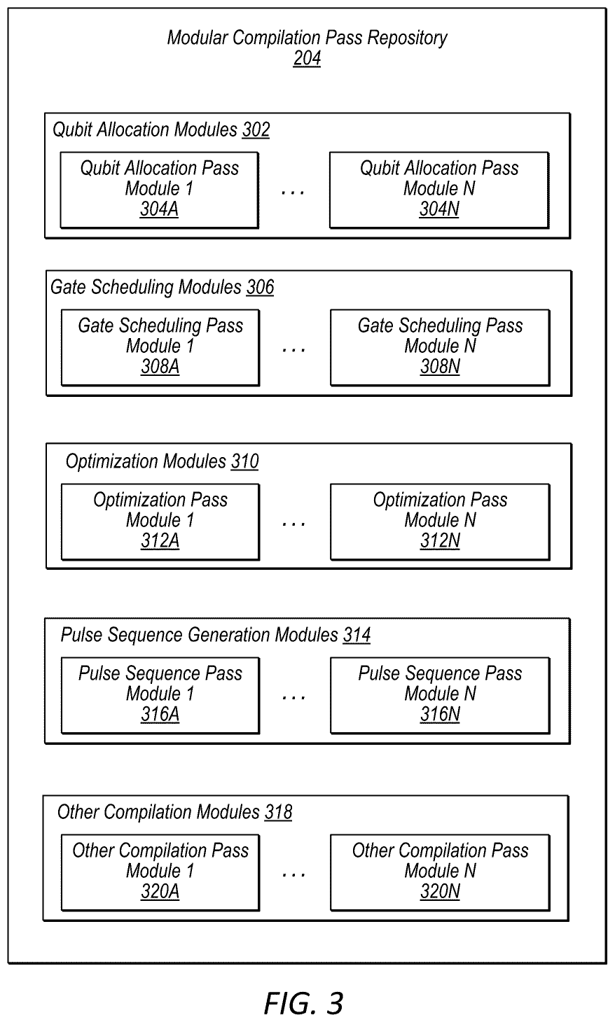

FIG. 3 illustrates example modular compilation passes that may be included in a modular compilation pass repository of the quantum circuit compilation service, according to some embodiments.

In some embodiments, modular compilation pass repository may include multiple modular compilation pass modules that may be selected for various steps of the compilation process. For example, the different modular compilation passes may be mixed and matched to form quantum compilation job plans that are customized to the needs of a given compilation job (e.g., quantum circuit that is to be compiled). For example, modular compilation pass repository 204 may include multiple qubit allocation modules 302, such as modules 304A through 304N, multiple gate scheduling modules 306, such as modules 308A through 308N, multiple optimization modules 310, such as optimization modules 312A through 312N, multiple pulse sequence generation modules 314, such as modules 316A through 316N, and one or more other compilation modules 318, which may include modules 320A through 320N.

In some embodiments, the respective sets of optimization modules of different types (e.g., qubit allocation modules 302, gate scheduling modules 306, optimization modules 310, pulse sequence generation modules 314, other compilation modules 318, etc.) may include varying number of optimization pass modules, wherein the respective passes vary in applicability based on quantum hardware technology, state of the partially compiled quantum circuit (prior to the performing of the respective pass), etc. In some embodiments, particular ones of the passes may be selected from the respective sets of optimization modules based on the circumstances of a given quantum circuit being compiled.

In some embodiments, past compilation experiences may be used to select which passes to use and what order in which to arrange selected passes. For example, a machine learning model may be used to perform pass selection, wherein the machine learning model provides recommendations for passes to include in a compilation job plan.

In some embodiments, a customer may specify one or more passes to be used, such as an SAT solver mapping optimization pass or an SMT solver mapping optimization pass. In some embodiments, passes may be selected based on constraints. For example, the quantum circuit compilation service and/or customer may specify a time limit for performing a compilation job or a budgeted amount of resources to be used to perform a compilation job. In such circumstances, compilation passes may be selected to comply with such constraints.

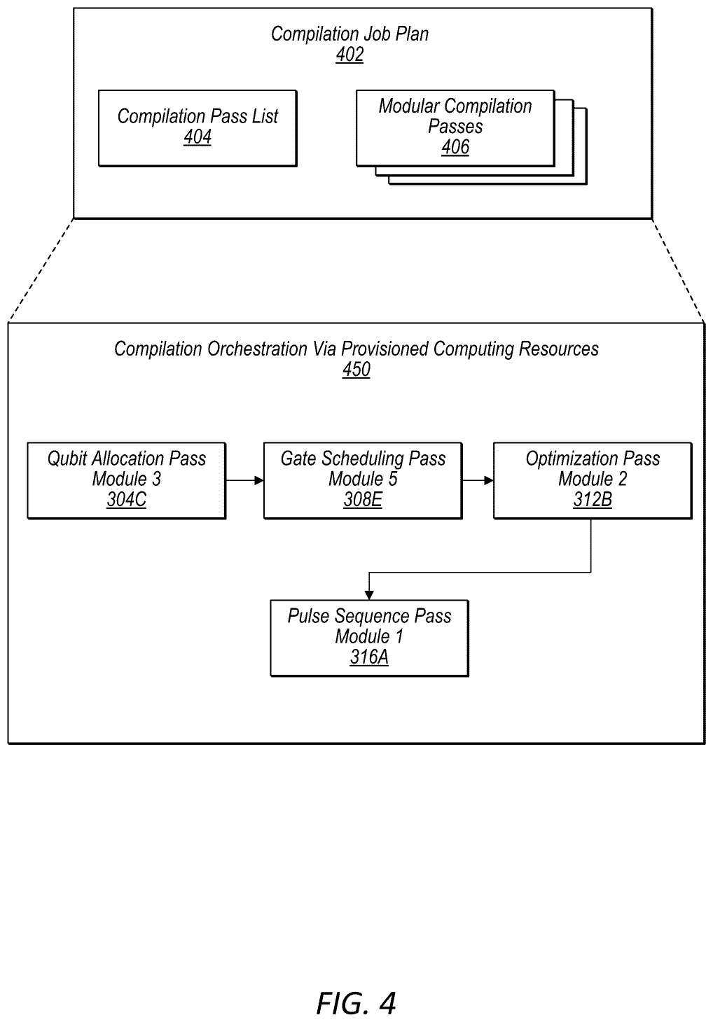

FIG. 4 illustrates an example quantum circuit compilation job plan that may be generated by the quantum circuit compilation service and also illustrates a workflow for orchestrating execution of the quantum circuit compilation job plan in order to at least partially compile a quantum circuit, according to some embodiments.

For example, in order to compile a given quantum circuit a quantum circuit compilation service 134 may generate a compilation job plan 402. The compilation job plan may include a compilation pass list 404. For example, a compilation pass list 404 may be generated by a compilation pass selection module 202 of a quantum circuit compilation service 134. Also, the compilation job plan 402 may include software modules for executing the selected compilation passes included in the compilation pass list 404. For example, compilation job plan 402 includes modular compilation passes 406. In some embodiments, modular compilation passes 406 may be retrieved from a modular compilation pass repository 204 of a quantum circuit compilation service 134.

In some embodiments, a compilation pass execution orchestration module 210 of a quantum circuit compilation service 134, along with computing resource provisioning module 206 of the quantum circuit compilation service 134, may orchestrate the execution of the compilation job plan 402. For example, the resource provisioning module 206 may reserve necessary computing resources to perform passes 304C, 308E, 312B, 316A, etc. as shown in 450 of FIG. 4 and the compilation pass execution orchestration module 210 may coordinate execution of the successive passes as shown in 450 using the resources reserved by computing provisioning resource module 206. In some embodiments, the respective modular compilation passes 406 may be configured as machine images that are used to boot computing resources reserved by computing resource provisioning module 206. The machine images may include code needed to perform respective specialized compilation passes.

Note that compilation orchestration via provisioned computing resources 450 is provided for ease of illustration. However, in some embodiments, more or fewer passes may be used and may be arranged in various configurations.

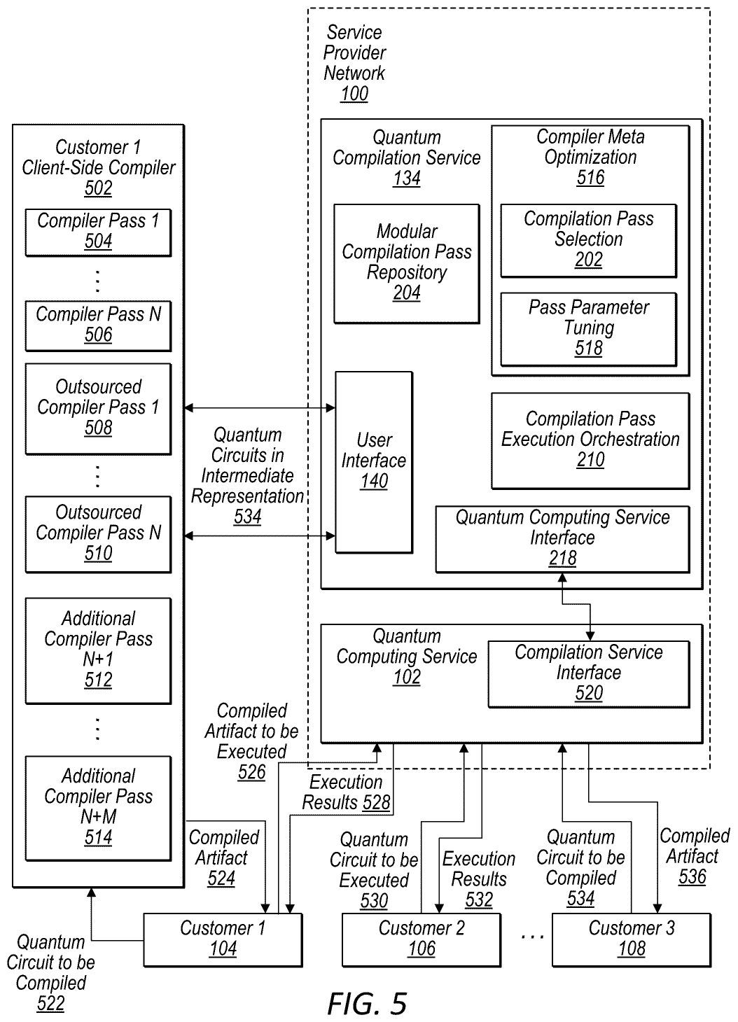

FIG. 5 illustrates an example quantum circuit compilation process, wherein a client-side compiler outsources one or more compilation passes to be performed by a quantum circuit compilation service, according to some embodiments.

In some embodiments, a quantum circuit compilation service, such as quantum circuit compilation service 134, may further include a compiler meta optimization module 516 that intelligently performs pass selection. For example, a model used for pass selection may be tuned via pass parameter tuning 518. In some embodiments, a module used for pass selection may be a machine learning model, and machine learning training may be performed to determine tuning parameters to be adjusted via pass parameter tuning 518.

In addition, in some embodiments, quantum computing service interface 218 may receive feedback from quantum computing service 102 via compilation service interface 520. The feedback may also be used by pass parameter tuning 518 to adjust passes. For example, feedback related to error rates, noise, calibration, etc. may be used to adjust parameters used within a given pass and/or to adjust pass selection. Also, in some embodiments, quantum computing service interface 218 may provide compiled artifacts to quantum computing service 102 via compilation service interface 520. For example, quantum circuit compilation service 134 may provide quantum computing service 102 a compiled quantum circuit that is to be executed using QPUs managed by quantum computing service 102 or QPUs of quantum hardware providers associated with quantum computing service 102.

In some embodiments, compilation of a quantum circuit may be performed in part using a client-side compiler, wherein the client-side compiler performs some compilation passes and outsources other compilation passes to quantum circuit compilation service 134.

For example, a client side compiler 502 of customer 1 (104) may perform client-side compiler passes 504 through 506, but may then outsource compiler passes 508 through 510 to quantum compilation service 134. The quantum circuit being compiled through compiler pass 506 may be passed to quantum compilation service 134 in an intermediate representation 534. Also, subsequent to quantum compilation service 134 performing outsourced compiler pass 510, a further compiled version may be passed back to client-side compiler 502 in an intermediate representation 534. Client-side compiler 502 may additionally perform additional compilations passes 512 through 514.

In some embodiments, a customer, such as customer 1 (104) may provide a quantum circuit to be compiled 522 to client-side compiler 502. The customer may then receive back a compiled artifact 524 and submit the compiled artifact 526 to quantum computing service 102 for execution, such as a “verbatim” execution. Also, the customer 1 (104) may receive execution results 528 back from the quantum computing service 102. For example, the quantum computing service 102 may execute the compiled artifact 526, for example at a local QPU (such as local QPU 1626 shown in FIG. 16) or may orchestrate execution of the compiled artifact on a QPU of an associated quantum hardware provider (such as QHPs 1602 shown in FIG. 16).

As another example, customer 2 (106) may provide a quantum circuit to be executed 530 to quantum computing service 102, and quantum computing service 102 may delegate compilation of the quantum circuit to be executed 530 to quantum compilation service 134. The quantum computing service 102 may provide the quantum circuit to be compiled (e.g., 530) to quantum compilation service 134 via compilation service interface 520 and may receive back a compiled artifact. The quantum computing service 102 may then execute the compiled artifact, for example at a local QPU (such as local QPU 1626 shown in FIG. 16) or may orchestrate execution of the compiled artifact on a QPU of an associated quantum hardware provider (such as QHPs 1602 shown in FIG. 16). The quantum computing service 102 may then return execution results 532.

As yet another example, customer 3 (108) may submit a quantum circuit to be compiled 534 to quantum computing service 102 (or directly to quantum compilation service 134) and receive back a compiled artifact 536. The customer 3 (108) may then submit the compiled artifact as a verbatim job to quantum computing service 102 or execute the compiled artifact on a third-party QPU or a QPU managed by customer 3 (108).

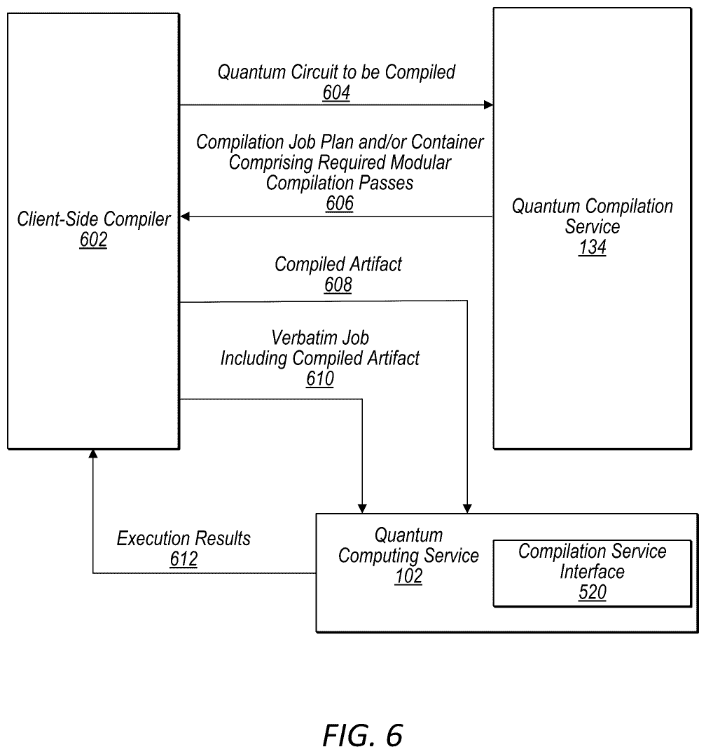

FIG. 6 illustrates an example quantum circuit compilation process, wherein a quantum compilation service provides a client-side compiler a containerized computing object comprising a quantum compilation job plan and modular compilation pass instructions for performing a set of modular compilation passes as indicated in the quantum compilation job plan, according to some embodiments.

For example, client-side compiler 602 may submit a quantum circuit to be compiled 604 to quantum circuit compilation service 134. The quantum circuit compilation service 134 may determine a compilation job plan, such as compilation job plan 402 shown in FIG. 4. However, in some embodiments, instead of executing the compilation job plan itself, the quantum circuit compilation service 134 may instead provide a software object 606 such as a container comprising a compilation pass list and instructions for performing modular compilation passes referenced in the compilation pass list to the client-side compiler 602. The client-side compiler 602 may then carry out the compilation using the provided compilation job plan. In some embodiments, the client-side compiler may substitute passes in the provided compilation job plan with a customer's own proprietary passes, but may use other provided modular compilation passes included in the job plan for other ones of the passes.

In some embodiments, a customer associated with client-side compiler 602 may manage execution of a compiled artifact, compiled via client-side router 602, or may submit (608) a compiled artifact to the quantum computing service 102, wherein the quantum computing service 102 manages execution of the compiled artifact. Additionally, the customer associated with client-side compiler 602 may submit the compiled artifact as a “verbatim” job at 610, wherein a “verbatim” job ensures that jobs that are sequentially executed are compiled in the same way. This may reduce variability, such as when jobs are used as part of performing an experiment. Execution results 612 of execution of the compiled artifact (either 608, 610, or both) may be provided back to the customer.

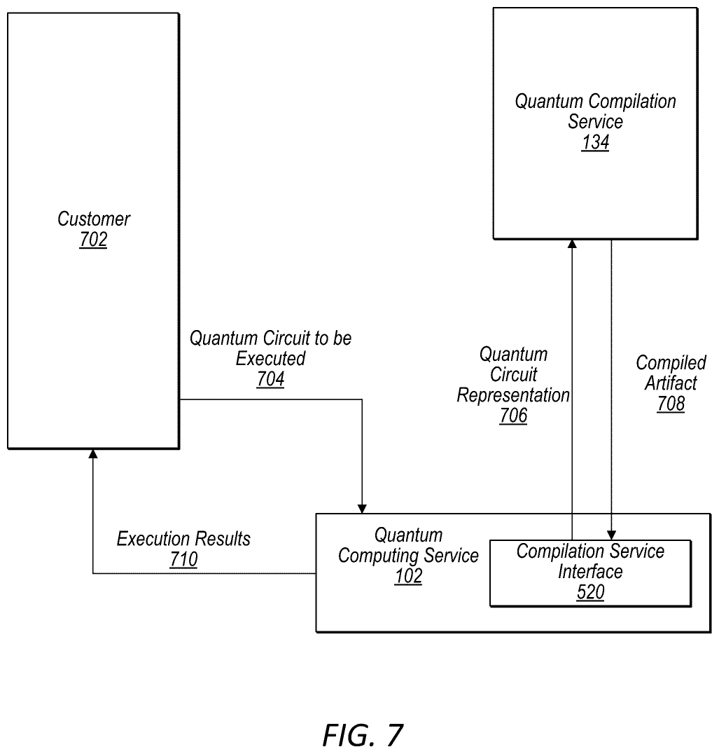

FIG. 7 illustrates an example quantum circuit compilation process, wherein a quantum compilation service performs quantum circuit compilation on behalf of a quantum computing service, wherein a customer submits a quantum circuit to be executed to the quantum computing service, the quantum computing service coordinates with the quantum circuit compilation service to compile the quantum circuit, and the quantum computing service executes the quantum circuit using a compiled artifact returned from the quantum circuit compilation service, according to some embodiments.

In some embodiments, a customer, such as customer 702, may submit a quantum circuit to be executed 704 to a quantum computing service 102. The quantum computing service 102 may (optionally) perform one or more tasks with regard to the quantum circuit to be executed 704, such as recommending a quantum hardware provider to be used to execute the quantum circuit and/or translating the quantum circuit into a representation that includes gates used by the selected quantum hardware provider (QHP). The quantum computing service 102 may also submit the quantum circuit 704 (in its original form or after translation into a QHP specific format) to quantum compilation service 134 via compilation service interface 520. For example, quantum circuit representation 706 is submitted to quantum compilation service 134 and compiled artifact 708 is returned. Quantum computing service 102 may coordinate execution of the compiled artifact 708, for example on a quantum processing unit (QPU) of the selected quantum hardware provider (QHP), and may return execution results 710 to customer 702.

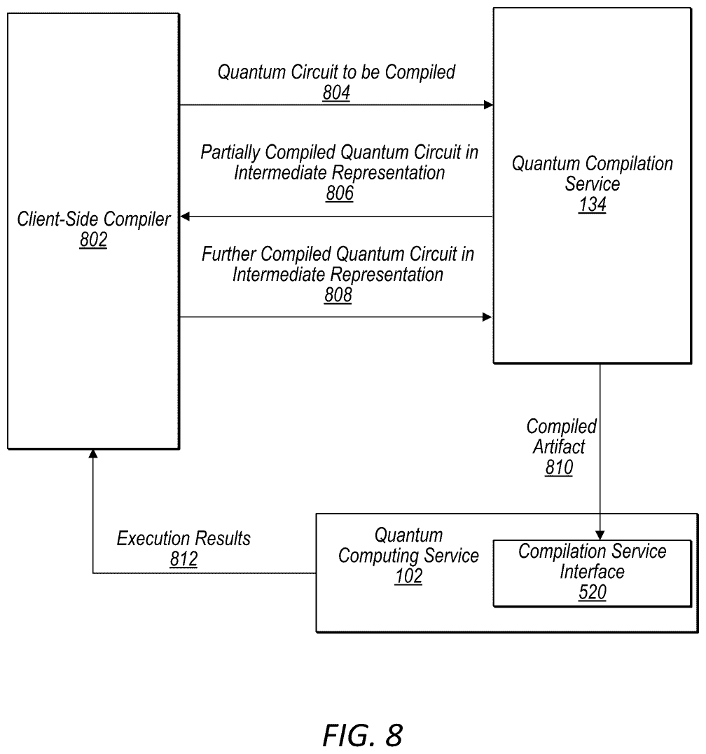

FIG. 8 illustrates an example quantum circuit compilation process, wherein a customer delegates quantum compilation to a quantum circuit compilation service, the quantum circuit compilation service partially compiles the quantum circuit, the quantum circuit compilation service returns the partially compiled quantum circuit to a client-side compiler, the client-side compiler performs one or more additional compilation passes, the client-side compiler then returns the further partially compiled quantum circuit to the quantum circuit compilation service, the quantum circuit compilation service completes compilation, and a quantum computing service executes the quantum circuit using a compiled artifact generated by the quantum circuit compilation service, according to some embodiments.

In some embodiments, client-side compiler 802 may submit quantum circuit to be compiled 804 to quantum compilation service 134. The quantum compilation service 134 may perform a sub-set of compilation passes and pass (at 806) a partially compiled version of the quantum circuit back to the client-side compiler 802. The partially compiled version of the quantum circuit may be formatted in an intermediate representation supported by the client-side compiler 802. The client-side compiler 802 may perform one or more additional compilation passes and pass (at 808) a further partially compiled version of the quantum circuit back to the quantum computing service 134. The quantum compilation service 134 may perform one or more additional passes, or if the quantum circuit returned from the client-side compiler 802 is fully compiled omit performing additional passes. The quantum compilation service 134 may then provide a compiled artifact 810 to quantum computing service 102 via compilation service interface 520. Quantum computing service 102 may coordinate execution of the compiled artifact 810, for example on a QPU of the selected QHP, and may return execution results 812 to customer 802.

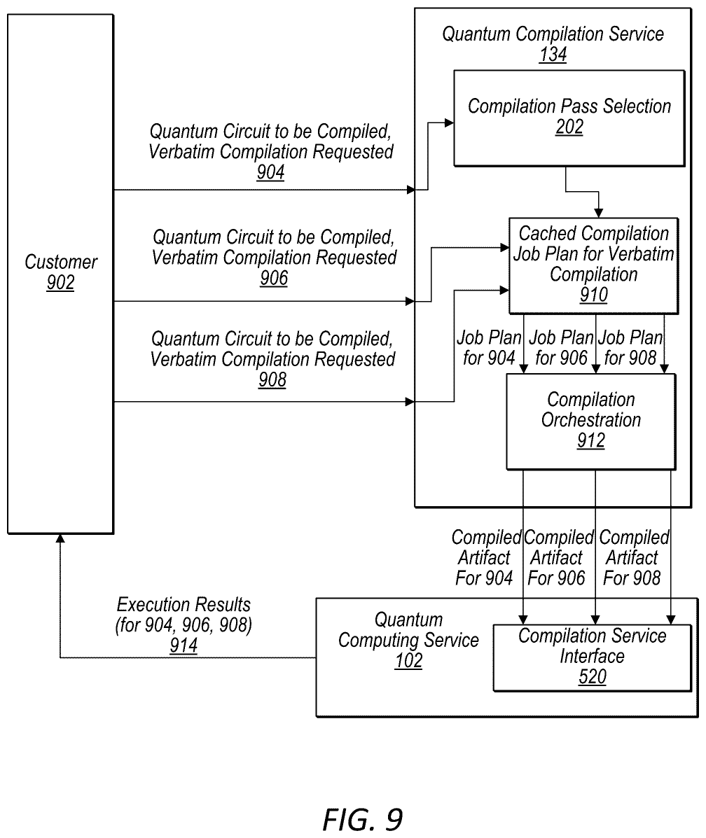

FIG. 9 illustrates example quantum circuit compilation processes that invoke a “verbatim” quantum circuit compilation, according to some embodiments.

In some embodiments, a customer of a quantum compilation service and/or of a quantum computing service may submit multiple jobs that the customer would like to be compiled in the same way, e.g., “verbatim.” For example, verbatim compilation may reduce variability that may otherwise result, for example due to selection of different compilation passes or different parameters within a compilation pass. In some situations, a customer may request “verbatim” compilation to reduce variability in the compilation process in order to get more repeatable results, such as may be used in controlled experiments.

A first job marked as verbatim, such as quantum circuit 904, may be processed at the quantum compilation service 134, for example by having pass selection performed by compilation pass selection module 202. A job plan for the verbatim circuit 904 may be stored in a cache such as cache 910 and also forwarded on to compilation orchestration 912 to generate a compiled artifact for the job 904. Subsequent jobs, such as quantum circuits 906 and 908 that are marked for verbatim compilation in reference to job 904, may be compiled using the same cached job plan stored in cache 912. The compiled artifacts for the respective verbatim jobs may be provided to quantum computing service 102 via compilation service interface 520. Quantum computing service 102 may coordinate execution of the compiled artifacts for jobs 904, 906, and 908, for example on a QPU of the selected QHP, and may return execution results 914 to customer 902.

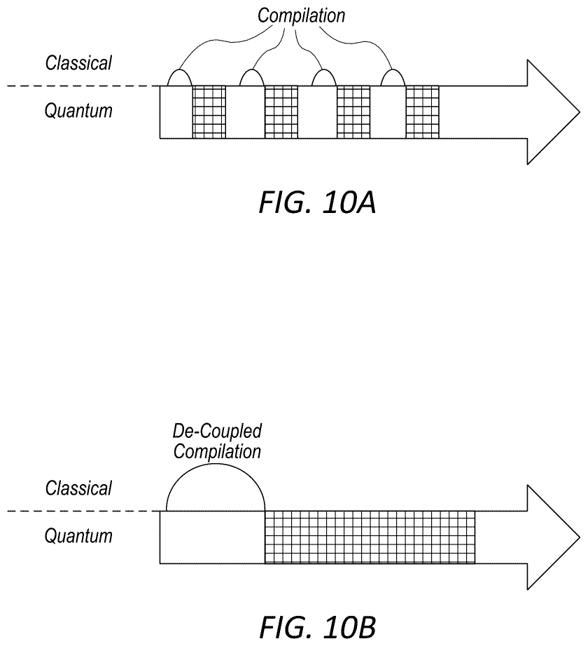

FIG. 10A illustrates an in-line compilation process, wherein compilation of quantum tasks is performed in-line with execution of the quantum tasks, according to some embodiments.

In some embodiments, compilation may be performed in-line with execution, as shown in FIG. 10A wherein classical computing operations are performed as part of compilation between successive iterations of quantum execution.

FIG. 10B illustrates a de-coupled quantum circuit compilation process, as may be performed by a quantum circuit compilation service, wherein compilation is performed in a de-coupled manner from quantum circuit execution, according to some embodiments.

In contrast to what is shown in FIG. 10A, in some embodiments, compilation may be performed up-front in a de-coupled manner with regard to execution. For example, as shown in FIG. 10B compilation may be performed for multiple jobs ahead of time and the jobs may be executed on a quantum computer in succession using pre-compiled artifacts. This may make better use of a limited access window for accessing a QPU as compared to in-line compilation as shown in FIG. 10A.

FIG. 11 illustrates an example of a web-based implementation of a user interface of the compilation service, according to some embodiments.

In some embodiments, interface 1100 may be implemented as a web-based graphical user interface, wherein a customer of service provider network 100 may upload and/or provide compilation service 134 with various information regarding a request for a quantum circuit compilation task that the customer would like completed.

In some embodiments, interface 1100 includes box 1102 in which a customer is asked what type(s) of inputs they can provide for the requested quantum compilation task. For example, in some embodiments wherein the quantum compilation task is a mapping task that involves optimization, such as SAT, SMT, etc. optimization, in order for compilation service 134 to prepare a quantum circuit mapping problem, compilation service 134 may need to receive and/or generate at least the following: a gate dependency list (see FIG. 12B); lists of physical qubits included in the target quantum hardware device and how respective ones of the physical qubits are connected via edges (see FIG. 12A). In some embodiments, a customer may additionally provide an indication of a number of SWAP gates the customer would like for the solver to attempt to use when solving. A customer may click on various options in fields 1102, 1104, and 1106 in order to provide said inputs directly and/or other inputs (e.g., logical quantum circuit information and/or physical qubit connectivity information) that compilation service 134 may use to generate the above inputs for the quantum circuit mapping problem.

In some embodiments, customers may additionally provide information regarding constraints to be applied as part of performing the compilation, such as convergence criteria, a confidence threshold, an amount of time acceptable to be used for compilation, a budgeted cost for performing the compilation, a number of iterations for which a solver is to seek an optimized mapping, etc.

In field 1102, a customer may click on various options such as “upload a gate dependency list,” in which a gate dependency list that corresponds to an order in which gates of the given logical quantum circuit are to be performed in (which is sometimes also ordered by logical qubit) may be uploaded. An example of a gate dependency list is shown in FIG. 12B herein. The uploaded gate dependency list may then be stored in gate dependency generations 1358 or 1558 (as a few examples), according to some embodiments. A customer may instead decide to click on “browse your saved quantum circuits,” in which a logical quantum circuit which has been stored in logical quantum circuit cache 1352 or 1552 (as a few examples) may be used to fulfill the current request shown in interface 1100. As another option, a customer may click on “upload a new quantum circuit,” in which a customer may upload a logical quantum circuit such as logical quantum circuit 1220 (shown in FIG. 12B). The uploaded logical quantum circuit may then be stored in logical quantum circuit cache 1352 or 1552 (as a few examples) and used by compilation service to generate a gate dependency list, according to some embodiments.

Alternatively, a customer of compilation service 134 may additionally be a customer of quantum computing service 102, and therefore may click on field 1104 to import a project from quantum computing service 102. For example, a customer may have a quantum algorithm project (wherein the given quantum algorithm comprises one or more quantum circuits that represent intermediate logical computations of the overall quantum algorithm) stored with quantum computing service 102 and may request that a quantum circuit mapping be solved for using compilation service 134.

In field 1106, a customer may click on various options such as “upload a physical qubit connectivity graph.” An example of a physical qubit connectivity graph is shown in FIG. 12A herein. The uploaded physical qubit connectivity graph may then be stored in physical qubit connectivity graph cache 1362 or 1562 (as a few examples), according to some embodiments. As introduced above, if a customer of compilation service 134 is also a customer of quantum computing service 102, they may be able to click on “select a quantum hardware provider,” and select a quantum hardware provider accessible via service provider network 100 (e.g., quantum hardware providers 124, 126, 128, 130, etc.). If the customer selects such an option, compilation service 134 may communicate with quantum computing service 102 in order to obtain information associated with the selected quantum hardware provider (e.g., a layout of a particular quantum hardware device, a physical qubit connectivity graph of a particular quantum hardware device, a list of physical qubits and edges for a particular quantum hardware device, etc.), according to some embodiments. Similarly, if a customer selects “select a qubit technology-we'll take care of the rest!” then compilation service 134 may communicate with quantum hardware provider recommendation 122 of quantum computing service 102 in order to recommend one or more quantum hardware providers to the customer, and, upon selection of one of the recommended quantum hardware providers, quantum computing service 102 may then provide physical qubit connectivity information pertaining to a quantum hardware device of the recommended quantum hardware provider to compilation service 134.

In some embodiments, certain combinations of inputs to fields 1102, 1104, and 1106 may depend on one another and therefore certain subfields of fields 1102, 1104, and/or 1106 may or may not be offered depending on selections of the customer. For example, if a customer selects field 1104 to import a project from quantum computing service 102, they may not also be able to select an option in field 1102. In a second example, if a customer selects field 1104 to import a project from quantum computing service 102, information imported from quantum computing service 102 about the particular project may already include information about the targeted quantum hardware provider, and therefore the customer may not be provided with the options in field 1106, as compilation service 134 may already have enough information to fulfill the given quantum circuit mapping request due to the imported project information selection in field 1104.

In field 1108, a customer may indicate whether full or partial compilation is to be performed. Also, the customer may specify which passes are to be performed by the compilation service 134. In some embodiments, a customer may further specify whether the compilation service is to return the compiled artifact to the customer, a client-side compiler of the customer, or provide the compiled artifact to a quantum computing service, such as quantum computing service 102, wherein the quantum computing service executes the quantum circuit using the compiled artifact.

In some embodiments, in field 1110 the customer may specify whether verbatim compilation is to be used for compiling a respective quantum circuit. Also, in fields 1112, 1114, and 1116, the customer may import custom compilation passes, custom gate decompositions, and/or custom pulse sequences to be used in compiling one or more quantum circuits on behalf of the customer.

After a customer is finished completing a combination of fields 1102, 1104, 1106, 1108, 1110, 1112, 1114, and/or 1116, they may use Submit button 1110 in order to launch their request to compilation service 134.

In some embodiments, interface 1100 may be implemented as a graphical user interface. However, interface 1100 may also be implemented as various types of programmatic (e.g., Application Programming Interfaces (APIs)) or command line interfaces to support the methods and systems described herein, according to some embodiments.

Furthermore, interface 1100 may be a customer-facing interface (e.g., user interface 140) in which a customer of compilation service 134 may submit inputs to be used for a given quantum circuit mapping problem, such as that which is shown in FIG. 1. Alternatively, a customer (e.g., customer 104, 106, 108, etc.) of quantum computing service 102 may request that a quantum algorithm that they provide to quantum computing service 102 be executed using quantum hardware device(s) of a given quantum hardware provider (e.g., quantum hardware provider 124, 126, 128, 130, etc.). As part of the fulfillment of said request, the quantum algorithm may be divided into one or more logical quantum circuits that represent intermediate logical computations used within the overall quantum algorithm. Those logical quantum circuit(s) may then be provided by quantum computing service 102 to compilation service 134 in order to generate quantum circuit mapping(s) of the logical quantum circuit(s) to quantum hardware device(s) of a given quantum hardware provider. In such embodiments, interface 1100 may not be a customer-facing interface but rather an interface (e.g., an API) between quantum computing service 102 and/or compilation service 134.

FIG. 12A illustrates an example of a physical qubit connectivity graph for a given quantum hardware device and the generation of corresponding physical qubit and edge lists, according to some embodiments.

In some embodiments, a description of physical qubit placements and respective connectivities to one another for a given quantum hardware device may resemble physical qubit connectivity graph 1200. A person having ordinary skill in the art should understand that physical qubit connectivity graph 1200 is used herein as an example, and that physical qubit connectivity graphs corresponding to other quantum hardware devices (e.g., quantum hardware devices provided by quantum hardware providers 124, 126, 128, 130, etc.) may include additional or less physical qubits than the four physical qubits shown in physical qubit connectivity graph 1200, and/or may be connected via edges that are placed in configurations other than that which is shown in physical qubit connectivity graph 1200.

In some embodiments, physical qubit connectivity graph 1200 demonstrates four physical qubits (e.g., physical qubits 1201, 1202, 1203, and 1204), wherein physical qubits 1201 and 1202 are physically connected via edge e₁, physical qubits 1202 and 1203 are physically connected via edge e₂, and physical qubits 1202 and 1204 are physically connected via edge e₃. Physical qubit connectivity graph 1200 may be used to generate both a list of the physical qubits (e.g., Physical qubits list: {q₃₀₁, q₃₀₂, q₃₀₃, q₃₀₄}) that may be used in order to complete a given quantum circuit mapping, and a list of edges that physically connect respective ones of the physical qubits (e.g., Edges list: ({e₁, e₂, e₃}).

In some embodiments, it may be implicitly understood via physical qubit connectivity graph 1200 that the following two-qubit gates may be performed according to the physical layout of the given quantum hardware device represented by physical qubit connectivity graph 1200: a two-qubit gate between physical qubits 1201 and 1202, a two-qubit gate between physical qubits 1202 and 1203, and a two-qubit gate between physical qubits 1202 and 1204. Similarly, the following two-qubit gates may not be (directly) performed according to the physical layout represented by physical qubit connectivity graph 1200: a two-qubit gate between physical qubits 1201 and 1204, and a two-qubit gate between physical qubits 1203 and 1204. If a given logical quantum circuit calls for a two-qubit gate between physical qubits 1201 and 1204 or between physical qubits 1203 and 1204 to be performed, a SWAP gate or other indirect method may be used to logically alter the states of two given physical qubits of qubits 1201, 1202, 1203, and 1204 in order to perform said gate.

In some embodiments, the above explanation of a physical qubit connectivity graph may be generalized into the following: a given physical qubit connectivity graph may comprise P physical qubits and K connected edges eᵢⱼ for i, j∈(0, P] and i≠j. Such information pertaining to physical qubit connectivity may then be initialized into the following: an ordered list E={d₁, . . . , dₖ, . . . , d_{K}} of edges, wherein each dₖ corresponds to an edge eᵢ_{ₖ}ⱼ_{ₖ} in the given physical qubit connectivity graph comprising P physical qubits and K edges that connect respective ones of the physical qubits. The order of edges eᵢⱼ in E may be chosen arbitrarily. Furthermore, for each dₖ, a larger physical qubit index that said dₖ connects may be written as dₖ·opₘₐₓ and a smaller physical qubit index that is also connected by dₖ may be written as dₖ·opₘᵢₙ, according to some embodiments. Such an initialization of a given physical qubit connectivity graph may be viewed as an initialization step and/or a pre-processing step performed by compilation service 134 in preparation for the given quantum circuit mapping to be encoded using an optimization solver, such as a SAT solver or SMT solver.

FIG. 12B illustrates an example of a logical quantum circuit and the generation of corresponding logical qubit, gate, and gate dependency lists, according to some embodiments.

In some embodiments, a logical quantum circuit submitted by a customer of service provider network 100 may resemble logical quantum circuit 1220. A person having ordinary skill in the art should understand that logical quantum circuit 1220 is used herein as an example, and that logical quantum circuits corresponding to other logical quantum computations may include additional or less logical qubits than the four logical qubits shown in logical quantum circuit 1220, and/or may include additional and/or other single or multi-qubit gates other than the six two-qubit gates which are shown in logical quantum circuit 1220.

In some embodiments, logical quantum circuit 1220 details six two-qubit gates that are to be performed between respective ones of the four logical qubits shown in order to complete a given quantum computation. Logical quantum circuit 1220 may be used to generate a list of logical qubits (e.g., Logical qubits list: {A, B, C, D}) and a list of gates that are to be performed between respective ones of said logical qubits (e.g., Gates list: {g₀, g₁, g₂, g₃, g₄, g₅}). A gate dependency list may additionally be generated in which, according to logical quantum circuit 1220, gate g₀ must be performed on logical qubit A before gate g₃ is performed on logical qubit A, and gate g₃ must be performed on logical qubit A before gate g₅ is performed on logical qubit A, etc.

In some embodiments, the above explanation of a logical quantum circuit may be generalized into the following: a given logical quantum circuit that is to be used in a quantum circuit mapping may be represented using V logical qubits and an ordered list of n two-qubit gates G={g₀, . . . , g₁, . . . , gₙ₋₁}. Such information pertaining to a logical quantum circuit description may then be initialized into the following: for g; in G, a larger gate operand may be denoted as gᵢ·opₘₐₓ and a smaller gate operand may be denoted as g₁·opₘᵢₙ, which are then initialized into an array. Both gᵢ·opₘₐₓ and gᵢ·opₘᵢₙ may be fixed for i∈[0, n). Furthermore, a gate dependency list for a generalized logical quantum circuit may be written as l_{g}={(g₁¹,g₂¹), . . . , (g₁ⁱ,g₂ⁱ), . . . }, wherein each pair of gates denotes that g₂ⁱ is dependent on g₁ⁱ and therefore cannot be scheduled before g₁ⁱ. As shown in FIG. 12B for the example of logical quantum circuit 1220, l_{g} may be generated by enumerating gate dependencies on each qubit (e.g., {A, B, C, D}={(g₀, g₃, g₅), (g₀, g₂, g₄), (g₁, g₂, g₅), (g₁, g₃, g₄)}). Such an initialization of a given logical quantum circuit be viewed as an initialization step and/or a pre-processing step performed by compilation service 134 in preparation for the given quantum circuit mapping to be encoded as a SAT solver problem or an SMT solver problem.

FIG. 13 illustrates an example modular compilation pass module, for example that may use an SAT solver to generate mappings of logical quantum circuits to quantum hardware devices, according to some embodiments.

In some embodiments, modular pass N 138 shown in FIG. 1 may be a mapping pass 1302 using a SAT solver as shown in FIG. 13. The mapping pass 1302 may be used to encode a quantum circuit mapping as an optimization problem, such as a SAT solver problem. Logical quantum circuit information 1350 and physical qubit connectivity information 1360 may be used to receive and store inputs and information pertaining to a quantum circuit mappings generated via compilation service 134, according to some embodiments. Such inputs may be submitted via user interface 140 (see description pertaining to interface 1100 herein). For example, logical quantum circuit cache 1352 may be configured to store logical quantum circuits (e.g., logical quantum circuit 1220) of one or more customers of compilation service 134, and logical qubit lists 1354 and gate lists 1356 may be configured to store lists of logical qubits and gates that correspond to respective logical quantum circuits (see also description with regard to FIG. 12B herein). In order to encode a quantum circuit mapping problem as a SAT solver problem, a gate dependency list may be generated, based on a given logical quantum circuit stored in logical quantum circuit cache 1352, as part of said encoding process, according to some embodiments. Such gate dependency generations may be stored in gate dependency generations 1358, according to some embodiments. In another example, physical qubit connectivity graph cache 1362 may be configured to store physical qubit connectivity graphs (e.g., physical qubit connectivity graph 1200) of one or more quantum hardware devices of quantum hardware providers (e.g., quantum hardware providers 124, 126, 128, 130) and/or physical qubit connectivity graphs provided by customers of compilation service 134. Physical qubit lists 1364 and edge lists 1366 may be configured to store lists of physical qubits and edges that correspond to respective physical qubit connectivity graphs. In some embodiments, in order to encode a quantum circuit mapping problem as a SAT solver problem, a physical qubit and edge lists may be generated, based on a given physical qubit connectivity graph stored in physical qubit connectivity graph cache 1362, as part of said encoding process.

In some embodiments, compilation service 134 be configured to use information in logical quantum circuit information 1350 and physical qubit connectivity information 1360, and a layout-transition-based order encoding scheme defined via SAT encoding definitions 1370 in order to generate a CNF equation that represents a given quantum circuit mapping problem. SAT encoding definitions 1370 may include one or more conditions, constraints, and/or other definitions used to encode quantum circuit mapping problems as SAT solver problems, such as gate scheduling condition(s) 1372, qubit mapping condition(s) 1374, SWAP operand selection condition(s) 1376, and/or other condition(s) 1378, according to some embodiments.

An encoded SAT solver problem may then be provided by compilation service 134 to an optimization problem service (e.g., optimization problem service 142, optimization problem service 144, etc.) such that the encoded SAT solver problem may be executed using a SAT solver (e.g., SAT solver 146). In some embodiments, an optimization problem service may be configured to implement SAT solving instances, in addition to instances of other optimization problem solving techniques (e.g., SMT solving, heuristic solving approaches, etc.).

Compilation service 134 may also orchestrate and/or coordinate the execution of the encoded SAT solver problem. For example, compilation service 134 may request certain compute resources, a time allocation, etc. in order to enable the execution of the encoded SAT solver problem using an optimization problem service. In some embodiments, compilation service 134 may communicate with optimization problem service 144 within service provider network 100 in order to coordinate the execution of a given encoded SAT solver problem using a SAT solving instance of SAT solver 146. In some embodiments, compilation service 134 may be configured to communicate with one or more other optimization problem services accessible via service provider network 100, such as optimization problem service 142, in which the optimization problem service may be located at a premises outside of service provider network 100. In such embodiments, compilation service 134 may communicate with optimization problem service 142 via an edge computing device physically located at a premises of optimization problem service 142 such that service provider network 100 may be extended. In some embodiments in which multiple encoded SAT solver problems are submitted for execution using SAT solving techniques, compilation service 134 may be further configured to coordinate the execution of said problems using multiple optimization problem services in order to conduct said executions more efficiently.

Compilation service 134 may also include one or more additional modules (e.g., other compilation modules 1338). For example, translation module 1380 may be configured to translate non-Clifford operations of a logical quantum circuit into a series of Clifford operations, and/or be configured to perform one or more other intermediate translations pertaining to a target quantum hardware provider. In another example, some two-qubit gates of a logical quantum circuit may be decomposed into a series of native gates, and gate nativization module 1382 may be configured to treat such decompositions. In yet another example, in some embodiments in which a quantum hardware provider of quantum hardware providers 124-130 pertains to Rydberg atom arrays, other compilation modules 1338 may include a module configured to compile and/or encode a mapping problem for determining atomic computational positions in Rydberg atom arrays, according to some embodiments.

FIG. 14 illustrates another example modular compilation pass module, for example that may use a reinforcement-learning-based machine learning model to generate mappings of logical quantum circuits to quantum hardware devices, according to some embodiments.

In some embodiments, modular pass M 136 may be a reinforcement learning based mapping module 1402 used to compile instructions including a quantum circuit mapping such that a logical quantum circuit may be executed, via said compiled instructions, using a quantum hardware device. A person having ordinary skill in the art should understand that FIG. 14 is meant to be a visual representation of compute instances and/or program instructions that, when executed, cause one or more processors to implement the methods and apparatus described herein, and that additional configurations of FIG. 14 may exist that fulfill said implementations and are meant to be included herein. Furthermore, FIG. 14 describes components of RL-based quantum circuit router 1450 as said components may be located within mapping modular pass M 136, according to some embodiments.

A person having ordinary skill in the art of machine learning techniques should understand that the following terms and definitions may be used to describe a reinforcement learning training model within both the context of solving quantum circuit mapping problems herein and within the context of generally understood machine learning techniques. In general, the reinforcement learning training model describes “actions” selected by an “agent,” wherein actions change an “environment” of the agent in order to “play” a quantum circuit mapping “game.” Within a context of quantum circuit mapping and the context of the methods and techniques described herein, an agent may be described as “player” of the quantum circuit mapping game in which the agent is aided by a neural network (e.g., policy network 1454) that determines a plurality of possible actions that change a current state of a quantum circuit mapping problem. An agent may then select an action from said plurality, and in some embodiments, the policy network may be further assisted via an MCTS algorithm that uses “inference” to determine predicted outcomes based on selecting respective ones of the actions. In addition, actions may be described herein as the scheduling of one or more SWAP gates. Furthermore, an “environment,” within the context of quantum circuit mapping, may be described via a current (e.g., initial, intermediate, final, etc.) state of a quantum circuit mapping problem, wherein an initial state of a quantum circuit mapping problem may be described as a state in which not all quantum gates of a logical quantum circuit have been scheduled for execution yet, an intermediate state of a quantum circuit mapping problem may be described as a state in which some additional quantum gates have been scheduled with respect to the initial state, and a final state of a quantum circuit mapping problem may be described as a state in which all quantum gates of the logical quantum circuit have been scheduled for execution, according to some embodiments.

As shown in FIG. 14, RL-based quantum circuit router 1450 may include compute resources configured to implement a neural network (e.g., policy network 1454) that may be assisted via a Monte Carlo Tree Search (MCTS) algorithm (Monte Carlo Tree Search (MCTS) 1452), according to some embodiments. In some embodiments, MCTS 1452 may use a “tree search” method to identify predicted outcomes of various actions determined via policy network 1454 and/or determine a loss associated with selecting those various actions.

In some embodiments, policy network 1454 may be configured to connect a current state of the environment (e.g., a given quantum circuit mapping problem) to actions that said policy network may determine and/or select. Examples of guidelines that may be used to guide the training and/or action selections of policy network 1454 may include the following. For example, a reinforcement learning model may select actions based, at least in part, on determining that certain actions of a plurality of actions will update a current state of the environment such that additional quantum gates of a given logical quantum circuit may be scheduled for execution. In another example, a reinforcement learning model may select actions based, at least in part, on gate dependencies of a given logical quantum circuit (e.g., a second quantum gate is dependent upon the output of a first quantum gate, etc.). A person having ordinary skill in the art should understand that RL model training guidelines are meant to be example guidelines that may be defined for an RL-based quantum circuit router and that additional and/or different guidelines may also be used to aid the direction of an RL-based quantum circuit router according to different mapping scenarios.

In some embodiments, agent 1456 may additionally comprise a value network (e.g., value network 1458), wherein said value network may be configured to determine quantum circuit routing rewards (e.g., reward distributions, reward weights, loss values, etc.) that may be used by policy network 1454 to provide a recommendation of a given action of a plurality to select. Examples of guidelines that may be used to guide a distribution of rewards determined via value network 1458 may include the following. For example, an agent of reinforcement learning training model may be rewarded proportionally higher for selecting an action that results in one or more quantum gates of a given logical quantum circuit being scheduled than for selecting a different action that does not result in one or more quantum gates being scheduled. In another example, an agent of reinforcement learning training model may be rewarded proportionally higher for successfully scheduling all quantum gates of a given logical quantum circuit than for failing to schedule all quantum gates of the given logical quantum circuit (this may be shortened to “losing the game” and/or “loss,”). In yet another example, an agent of reinforcement learning training model may be rewarded proportionally higher for successfully scheduling all quantum gates of a given logical quantum circuit with a fewer number of scheduled SWAP gates than for successfully scheduling all quantum gates of the given logical quantum circuit with a larger number of scheduled SWAP gates, as this solves the given quantum circuit mapping problem using a more efficient path. A person having ordinary skill in the art should understand that such RL reward guidelines are meant to be example guidelines that may be defined for an RL-based quantum circuit router and that additional and/or different guidelines may also be used to aid the action recommendation determined via the RL model according to different mapping scenarios.

Modular pass M 136 may additionally include various memory caches in order to provide RL-based quantum circuit router 1450 with access to frequently used information. Such memory caches may be configured as compute resources of quantum compilation service 134, according to some embodiments. As shown in FIG. 14, RL-based quantum circuit router experience generations 1462 may include logical quantum circuit cache 1464, physical qubit connectivity graph cache 1466, qubit allocation cache 1468, experience replay buffer 1470, sampled historical experience cache, and compiled instructions 1474. In some embodiments, logical quantum circuit cache may be used to store various logical quantum circuits that RL-based quantum circuit router 1450 may be in the process of mapping. In some embodiments, logical quantum circuit cache may store logical quantum circuits submitted by customers of service provider network 100, and/or logical quantum circuits used to train a given RL-based quantum circuit routing instance 1450 (e.g., “training games”).

In some embodiments, physical qubit connectivity graph cache 1466 may be used to store various physical qubit connectivity graphs corresponding to quantum hardware devices, such as quantum hardware devices of quantum hardware providers 124, 126, 128, and 130. Physical qubit connectivity graph cache 1466 may store information pertaining to said quantum hardware devices, and/or may store information on how to request such information (e.g., via quantum computing service 102). Furthermore, physical qubit connectivity graph cache 1466 may store physical qubit connectivity graphs (e.g., physical qubit connectivity graph 1220, etc.), ordered lists of physical qubits and how they are connected to one another via edges, and/or any equivalent information that describes connectivities of physical qubits on a given quantum hardware device.

In some embodiments, qubit allocation cache 1468 may be used to store various qubit allocation schemes that may be used during the solving of corresponding quantum circuit mapping problems. In some embodiments, a customer may submit a given qubit allocation scheme during submission of a given quantum circuit mapping request to quantum compilation service 134 and said qubit allocation scheme may be stored in qubit allocation cache 1468. In other embodiments, quantum compilation service 134 may generate a qubit allocation scheme using information about a given logical quantum circuit stored in logical quantum circuit cache 1464 and information about connectivity of a given quantum hardware device stored in physical qubit connectivity graph cache 1466, and store said qubit allocation scheme in qubit allocation cache 1468.

In some embodiments, experience replay buffer 1470 may be used to store various states of an environment within a given quantum circuit mapping problem. For example, if an agent of RL-based quantum circuit router 1450 has already selected a given number of actions, experience replay buffer 1470 may store information pertaining to how the state of the environment has been updated following the selection of each of the selected actions. In another example, experience replay buffer 1470 may store quantum circuit mapping determination scenarios that have already been completed by RL-based quantum circuit router 1450 such that experience replay buffer 1470 grows over time.

In some embodiments, sampled historical experience cache 1472 may be used to store various quantum circuit mapping problems that have been previously solved and/or attempted by RL-based quantum circuit router 1450. For example, an agent of RL-based quantum circuit router 1450 may search sampled historical experience cache 1472 to determine if a particular scenario and/or similar scenario during a current quantum circuit mapping problem has been solved for already in a previously attempted quantum circuit mapping problem.

In some embodiments, compiled instructions 1474 may be used to store results to various on-going or previously completed quantum circuit mapping problems. For example, quantum compilation service 134 may be configured to compile instructions including a quantum circuit mapping result for executing a logical quantum circuit using a given quantum hardware device, and compiled instructions 1474 may be used to retrieve said quantum circuit mapping result in order to compile the instructions, which may then be provided to quantum computing service 102.

In some embodiments, RL-based quantum circuit router experience generations 1462 may additionally store information pertaining to simple quantum circuit mapping scenarios that may be used to train and/or improve a reinforcement learning training model. Additionally, or alternatively, such “training games” may include an ordered list of training scenarios that should be used to train and/or improve a reinforcement learning training model if program instructions were to be executed such that instances of RL-based quantum circuit router 1450 were to be installed on additional servers (either inside or outside of service provider network 100). In some embodiments, such training games may be used in order to train RL-based quantum circuit router 1450 via a reinforcement learning training model. In other embodiments, a trained reinforcement learning model may include agent 1456 and policy network 1454, wherein policy network 1454 already has some level of prior training via a reinforcement learning training model. In some embodiments in which computing resources may be limited, it may be advantageous to apply the trained reinforcement learning model for a given quantum circuit mapping problem of a customer of service provider network 100.

In some embodiments, quantum compilation service 134 may also leverage multiple RL-based quantum circuit routing compute instances (e.g., RL-based quantum circuit router(s) 1450) in order to run multiple quantum circuit mapping problems simultaneously, which may speed up a process of generating a quantum circuit mapping and/or allow quantum compilation service to manage quantum circuit mapping problems of multiple customers of the service provider network simultaneously. In some embodiments, different instances of RL-based quantum circuit router(s) 1450 may be specifically trained for a certain set and/or subset of qubit technologies. For example, a first RL-based quantum circuit routing instance 1450 may be trained using training scenarios that pertain to annealing-based quantum hardware devices, and may be configured to generate compiled instructions for executing logical quantum circuits using quantum hardware devices of quantum hardware provider 124. In another example, a second RL-based quantum circuit routing instance 1450 may be trained using other training scenarios that pertain to superconducting-based quantum hardware devices, and may be configured to generate compiled instructions for executing logical quantum circuits using quantum hardware devices of quantum hardware provider 128.

FIG. 15 illustrates an additional example modular compilation pass module, for example that may use an SMT solver to generate mappings of logical quantum circuits to quantum hardware devices, according to some embodiments.

In some embodiments, modular pass L may be a mapping pass 1502 using a SMT solver as shown in FIG. 15. The mapping pass 1502 may be used to encode a quantum circuit mapping as an optimization problem, such as a SMT solver problem. Logical quantum circuit information 1550 and physical qubit connectivity information 1560 may be used to receive and store inputs and information pertaining to a quantum circuit mappings generated via compilation service 134, according to some embodiments. Such inputs may be submitted in a similar manner as described with regard to the SAT solver compilation pass module described above with regard to FIG. 13 and may include logical quantum circuit cache 1552, logical qubit lists 1554, gate lists 1556, and gate dependency generations 1558. Also, they may include physical qubit connectivity graph cache 1562, physical qubit lists 1564, and edge lists 1566.

In some embodiments, compilation service 134 be configured to use information in logical quantum circuit information 1550 and physical qubit connectivity information 1560 to generate an SMT optimization problem. For example the problem may be constructed using SMT encoding definitions 1570, including gate scheduling conditions 1572, qubit mapping conditions 1574, and symbolic bit matrix representations for circuit elements of a Clifford Circuit design problem 1576.

An encoded SMT solver problem may then be provided by compilation service 134 to an optimization problem service (e.g., optimization problem service 142, optimization problem service 144, etc.) such that the encoded SMT solver problem may be executed using a SMT solver (e.g., SMT solver 146). In some embodiments, an optimization problem service may be configured to implement SMT solving instances, in addition to instances of other optimization problem solving techniques (e.g., SAT solving, heuristic solving approaches, etc.).

Compilation service 134 may also orchestrate and/or coordinate the execution of the encoded SMT solver problem. For example, compilation service 134 may request certain compute resources, a time allocation, etc. in order to enable the execution of the encoded SMT solver problem using an optimization problem service. In some embodiments, compilation service 134 may communicate with optimization problem service 144 within service provider network 100 in order to coordinate the execution of a given encoded SMT solver problem using a SMT solving instance of SMT solver 146. In some embodiments, compilation service 134 may be configured to communicate with one or more other optimization problem services accessible via service provider network 100, such as optimization problem service 142, in which the optimization problem service may be located at a premises outside of service provider network 100. In such embodiments, compilation service 134 may communicate with optimization problem service 142 via an edge computing device physically located at a premises of optimization problem service 142 such that service provider network 100 may be extended. In some embodiments in which multiple encoded SMT solver problems are submitted for execution using SMT solving techniques, compilation service 134 may be further configured to coordinate the execution of said problems using multiple optimization problem services in order to conduct said executions more efficiently.

Compilation service 134 may also include one or more additional modules (e.g., other compilation modules 1538). For example, translation module 1580 may be configured to translate non-Clifford operations of a logical quantum circuit into a series of Clifford operations, and/or be configured to perform one or more other intermediate translations pertaining to a target quantum hardware provider. In another example, some two-qubit gates of a logical quantum circuit may be decomposed into a series of native gates, and gate nativization module 1582 may be configured to treat such decompositions. In yet another example, in some embodiments in which a quantum hardware provider of quantum hardware providers 124-130 pertains to Rydberg atom arrays, other compilation modules 1538 may include a module configured to compile and/or encode a mapping problem for determining atomic computational positions in Rydberg atom arrays, according to some embodiments.

FIG. 16 illustrates edge computing devices of a quantum computing service physically located at quantum hardware provider locations, according to some embodiments.

In some embodiments, service provider network 100, as illustrated in FIG. 1, may include one or more data centers connected to each other via private or public network connections. Also, edge computing devices located at quantum hardware provider locations may be connected to a service provider network via private or public network connections. For example, service provider network 100 illustrated in FIG. 16 includes data centers 1606a, 1606b, and 1606c that are connected to one another via private physical network links of the service provider network 100. In some embodiments, a customer of the service provider network may also be connected via a private physical network link that is not available to the public to carry network traffic, such as a physical connection at a router co-location facility. For example, customer 1610 is connected to a router associated with data center 1606c via direct connection 1624. In a similar manner, edge computing devices located at quantum hardware provider locations may be connected to a service provider network via a private physical network link that is not available to carry public network traffic.

For example, edge computing device 1604a located at quantum hardware provider location 1602a is connected to a router at data center 1606a via direct connection 1618. In a similar manner, edge computing device 1604b at quantum hardware provider location 1602b is connected to a router at data center 1606b via direct connection 1620. Also, edge computing device 1604c at quantum hardware provider 1602c is connected to a router at data center 1606c via direct connection 1622.

Also, in some embodiments an edge computing device of a service provider network located at a quantum hardware provider location may be connected to the service provider network via a logically isolated network connection over a shared network connection, such as via the Internet or another public network. For example, edge computing device 1604d at quantum hardware provider location 1602d is connected to data center 1606c via a logically isolated network connection via network 1616. In a similar manner, in some embodiments a customer, such as customer 1614, may be connected to service provider network 100 via public network 1612.

In some embodiments, similar configurations may exist between compilation service 134 and optimization problem service 142. For example, compilation service 134 may be connected to optimization problem service 142 by using a logically isolated network connection via a public network, or by using a dedicated physical non-public network link. In some embodiments, another edge computing device may be placed at a premises of optimization problem service 142 such that compilation service 134 may be connected to optimization problem service 142 via an edge computing device.

In some embodiments, a quantum computing service such as quantum computing service 102 and/or a quantum circuit compilation service, such as compilation service 134, may be implemented using one or more computing devices in any of data centers 1606a, 1606b, 1606c, etc. In some embodiments, network connection 1612 and/or direct connect 1624 may be used to pass partially compiled quantum circuits in an intermediate representation between a client-side compiler and a quantum circuit compilation service, such as compilation service 134. Also, quantum computing service 102 may provide customers, such as customer 1614 or customer 1610, access to quantum computers in any of quantum hardware provider locations 1602a, 1602b, 1602c, 1602d, etc. For example, a customer may not be restricted to using a quantum hardware provider in a local region where the customer is located. Instead, the customer may be allocated compute instances instantiated on a local edge computing device located at a selected quantum hardware provider location, such that the location of the customer does not restrict the customer's access to various types of quantum computing technology-based quantum computers.

In some embodiments, one or more of the data centers 1606 may also include local quantum hardware devices, such as local QPUs 1626. One or more of data centers 1606 may also include a local optimization problem service, such as optimization problem service 144 in which one or more computing devices at data centers 1606 are configured to perform various optimization solving techniques such as SAT solving, SMT solving, etc. (e.g., solver 146, solver 148, etc.).

### Example Edge Computing Device Located at a Quantum Hardware Provider Location

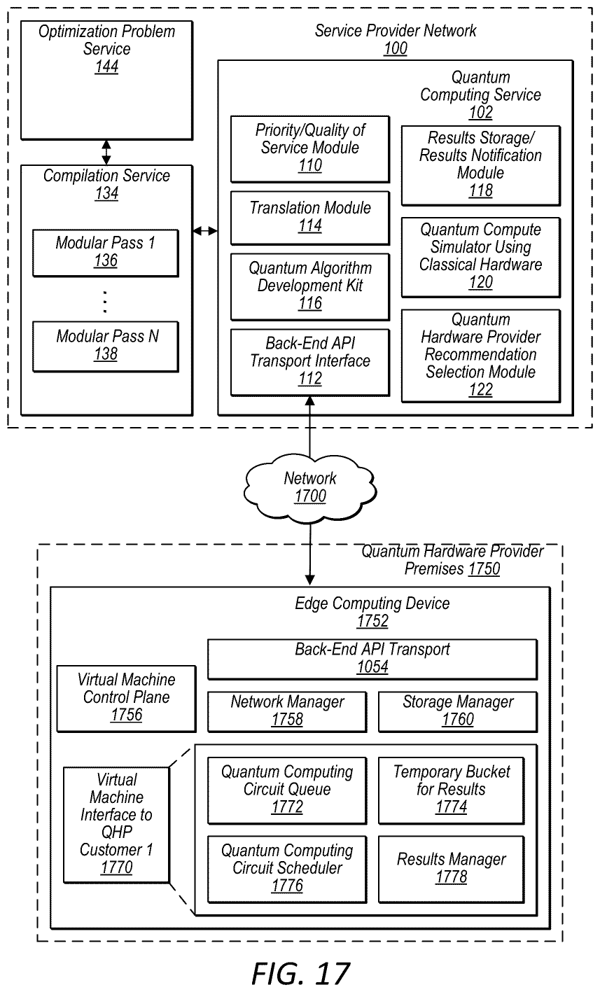

FIG. 17 illustrates an example edge computing device connected to a quantum computing service, according to some embodiments.

Service provider network 100 and quantum computing service 102 may be similar to the service provider networks and quantum computing services described herein, such as in FIG. 1. Also, edge computing device 1752 may be a similar edge computing device as any of the edge computing devices described previously, such as in FIG. 1 or 16. Edge computing device 1752 may be connected to service provider network 100 via network connection 1700, which may be a logically isolated network connection via a public network, a dedicated physical non-public network link, or other suitable network connection.

Edge computing device 1752 may include network manager 1758, storage manager 1760, and virtual machine control plane 1756.

In some embodiments, a back-end application programmatic interface (API) transport of an edge computing device, such as back-end API transport 1754 of edge computing device 1752 may ping a quantum computing service to determine if there are one or more quantum tasks (e.g., compiled quantum circuits) waiting to be transported to the edge computing device. The edge computing device may further use a non-public back-end API transport, such as back-end API transport 1754 to bring the compiled quantum circuit into the edge computing device 1752.

Additionally, for each customer, a back-end API transport of an edge computing device of a quantum computing service, such as back-end API transport 1754 of edge computing device 1752, may cause a virtual machine to be instantiated to manage scheduling and results for a given compiled quantum circuit pulled into the edge computing device from a back-end API. For example, virtual machine 1770 may act as an interface to the quantum hardware provider for a given customer (e.g., customer 1) of the service provider network. The edge computing device may be directly connected to a local non-public network at the quantum hardware provider location and may interface with a scheduling component of the quantum hardware provider to schedule availability (e.g., usage slots) on a quantum computer of the quantum hardware provider.

In some embodiments, the virtual machine 1770 may be booted with a particular machine image that supports interfacing with the scheduling component of the quantum hardware provider, wherein different quantum hardware providers require different scheduling interfaces.

In some embodiments, virtual machine 1770 may be booted with a quantum circuit queuing component 1772, a quantum circuit scheduling component 1776, a component that manages a local storage bucket on the edge computing device to temporarily store results, such as temporary bucket 1774 and results manager 1778. In some embodiments, quantum circuit scheduling component 1776 may order compiled quantum circuits in quantum circuit queuing component in the order they are received, wherein the received order enforces quality of service (QOS) guarantees by ordering the quantum tasks in the quantum task queue of the quantum computing service based on priorities determined using the QoS guarantees.

In some embodiments, an edge computing device, such as edge computing device 1752, may support multi-tenancy (e.g., service multiple customers of service provider network 100). Also, in some embodiments, edge computing device 1752 may also instantiate virtual machines that execute classical computing tasks, such as a classical computing portion of a hybrid algorithm. For example, virtual machine 1770 may be further configured to perform classical compute portions of a hybrid algorithm.

In some embodiments, a quantum circuit compilation service, such as compilations service 134, may perform de-coupled compilation as discussed in FIG. 10B. In such embodiments, execution of quantum portions of hybrid algorithms may need be delayed while waiting on in-line compilation to be performed. For example, as opposed to in-line compilation as shown in FIG. 10A, wherein compilation is performed in-line before each quantum task, instead in de-coupled compilation, the compilation work may be performed ahead of time so that minimal delays are incurred when executing quantum tasks during an allocated availability window on a quantum processing unit, such as may be provided by a quantum hardware provider.

In some embodiments, a back-end API transport of an edge computing device located a quantum hardware provider location may interface with a back-end API transport interface 112 of a computing device at a remote location where one or more computing devices that implement the quantum computing service are located.

Note that edge computing device 1752 may be physically located (e.g., co-located) at quantum hardware provider premises 1750, such as in a building of a quantum hardware provider facility.

In some embodiments, the components of virtual machine 1770 may be included in back-end API transport 1754, and the back-end API transport 1754 may execute the related components within the back-end API transport without causing a separate VM 1770 to be instantiated.

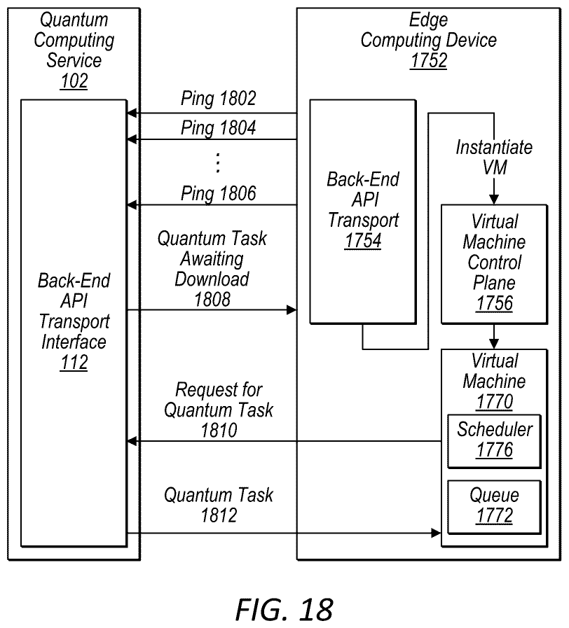

FIG. 18 illustrates example interactions between a quantum computing service and an edge computing device of the quantum computing service, according to some embodiments.

A back-end API transport 1754 of edge computing device 1752 may submit pings 1802, 1804, 1806, etc. to quantum computing service 102 to determine whether there is a quantum task (e.g., a compiled quantum circuit) to be transported to edge computing device 1752. At 1808, the quantum computing service 102 may indicate to the edge computing device 1752 that there is a compiled quantum circuit (e.g., a logical quantum circuit, such as logical quantum circuit, that has been mapped to a given quantum hardware device of a given quantum hardware provider and translated into a format acceptable by the quantum hardware provider) ready to be transported to the edge computing device 1752.

In some embodiments, the compiled quantum circuit may represent a logical quantum circuit that has been flattened into a native gate representation, or may be in an intermediate representation that is to be further compiled by the quantum hardware provider. Also, in some embodiments, the compiled quantum circuit may be compiled by a quantum compilation service into a pulse-level compiled artifact that can be executed, for example via an FPGA of a quantum processing unit (QPU) to execute the compiled quantum circuit on the QPU.

In response to an indication that there is a compiled quantum circuit ready for transport, back-end API transport 1754 may cause virtual machine control plane 1756 to instantiate a virtual machine 1770 to act as an interface for the customer to the quantum hardware provider. At 1810 the VM 1770 may call the back-end API transport 1754 requesting the compiled quantum circuit (e.g., quantum task or batch of quantum tasks). In response, at 1812, the back-end API transport 1754 may cause the compiled quantum circuit (e.g., quantum task or batch of quantum tasks) to be transported to the queue 1772 of VM 1770. In some embodiments, instead of pings of a polling protocol, an edge computing device 1752 may use various other techniques to determine whether there is a quantum computing circuit (e.g., quantum task or batch of quantum tasks) ready to be transported to edge computing device 1752. Also, in some embodiments, a given quantum hardware provider may include more than one quantum computer and/or types of quantum computers. In such embodiments, a back-end API transport and/or VM interface to the quantum hardware provider may route a quantum circuit that is to be executed at the quantum hardware provider to an assigned quantum computer at the quantum hardware provider.

In some embodiments, quantum tasks may come over to queue 1772 with associated access tokens and the quantum tasks may be ordered in queue 1772 based on their respective access tokens, or time stamps included in the respective access tokens.

### Example Process Performed by a Cloud-Based Quantum Circuit Compilation Service

At block 1900 a cloud-based quantum circuit compilation service receives a quantum circuit to be compiled. The quantum circuit to be compiled may be received from a given customer of a plurality of customers of the cloud-based quantum computing service. In some embodiments, the quantum circuit to be compiled that is received from the given customer may be received via a user interface accessed by the given customer. Also, in some embodiments, the quantum circuit to be compiled may be received from a client-side compiler of the given customer, such as in the format of a partially compiled quantum circuit. As an example, the customer may have performed various quantum circuit compilation passes using the client-side compiler, but may outsource other compilation passes to the quantum circuit compilation service. As an example, gate mapping passes that can be improved by using optimization solvers may be outsourced to the quantum circuit compilation service. For example, the client-side compiler may lack sufficient computing resources or licensing privileges to solve complex optimization problems, such as NP hard problems. However, the quantum circuit compilation service may be able to scale provisioned computing resources as needed to solve such NP hard problems. Also, the quantum circuit compilation service may have access to an optimization problem service, such as the cloud-based optimization problem service 144 or the third-party optimization problem service 142. Thus, the quantum circuit compilation service may provide superior computing capacity and access to solvers that the client-side compiler does not have access to.

In some embodiments, a quantum compilation service may be configured to compile respective quantum circuits that are to be executed on respective ones of a plurality of different quantum hardware devices that are based on different quantum computing technologies. For example, the quantum circuit to be compiled received at 1900 may be a quantum circuit to be compiled for execution on various different quantum hardware devices that use various different quantum computing technologies.

At block 1902, the cloud-based quantum circuit compilation service determines a set of compilation passes to be performed to compile (or partially compile) the received quantum circuit. In some embodiments, rules may be defined by a customer or administrator, wherein the rules are used to select and order compilation passes to be performed based on characteristics of the quantum circuit that is to be compiled and/or based on customer preferences. In some embodiments, a machine learning model may be trained and used to select and order compilation passes to be performed for respective quantum circuits based on characteristics of the quantum circuits. In some embodiments, the selected compilation passes may be selected from a set of available compilation passes stored in a modular compilation pass repository, such as modular compilation pass repository 204. In some embodiments, a customer may submit their own custom compilation passes that are (at least temporarily) added to the modular compilation pass repository and that are made available for use in compiling quantum circuits for the customer. In some embodiments, a customer may also submit custom gate decomposition definitions and/or custom pulse sequences that are to be used when compiling quantum circuits for the customer.

At block 1904, the quantum circuit compilation service selects a first (or next) modular compilation pass that is to be performed.

At block 1906, the quantum circuit compilation service retrieves instructions for executing the selected compilation pass from the modular compilation pass repository. For example, as shown in FIG. 4 a compilation job plan 402 may include a compilation pass list 404. The first (or next) compilation pass to be performed may be determined based on the compilation pass list 404. The quantum circuit compilation service may then retrieve instructions for executing the compilation pass from the modular compilation passes 406, which may include the instruction or may include a pointer for retrieving the instructions from the modular compilation pass repository. For example, the pass may be a mapping pass using a SAT solver, and the instructions for the modular pass may include instructions for orchestrating an optimization problem using a SAT solver service to perform the mapping. Also, the instructions may indicate computing resources that will be needed to perform the modular compilation pass.

At block 1908, the quantum circuit compilation service automatically orchestrates the provisioning of computing resources needed to be perform the compilation pass. For example, virtual machines may be instantiated in order to provide necessary computing resources to perform the compilation pass.

At block 1910, the quantum circuit compilation service causes the compilation pass to be performed using the provisioned computing resources and the retrieved instructions for performing the compilation pass. As discussed herein, the results of the compilation pass may be a partially compiled quantum circuit that can be returned to the customer for compilation. Also, the results of the compilation pass may be used as an input to a subsequent compilation pass. In some embodiments, the results of one or more compilation passes may be a compiled artifact that is configured to be provided to a QHP either for further compilation and/or execution. In some embodiments, the quantum circuit compilation service may perform compilation down to a pulse-sequence level, and the compiled artifact may be a compiled binary for implementing pulse sequences.

At block 1912, the quantum circuit compilation service determines, based on the compilation job plan, whether or not there are additional compilation passes that are to be performed by the quantum circuit compilation service. If there are yet to be performed compilation passes, the process reverts to block 1904 and is repeated for a next compilation pass to be performed. If, at block 1912, it is determined, based on the compilation job plan, that there are not any additional compilation passes that are to be performed, the quantum circuit compilation service provides a compiled artifact representing a compiled version of the quantum circuit. The compiled artifact may be provided to a customer for further client-side compilation. Also, the compiled artifact may be provided to the customer in a format for execution on a QPU of the customer. Additionally, the compiled artifact may be provided to a quantum computing service of the provider network that will coordinate execution of the compiled artifact using a QPU of a remote quantum hardware provider or using an internal QPU of the service provider network.

### Illustrative Computer System

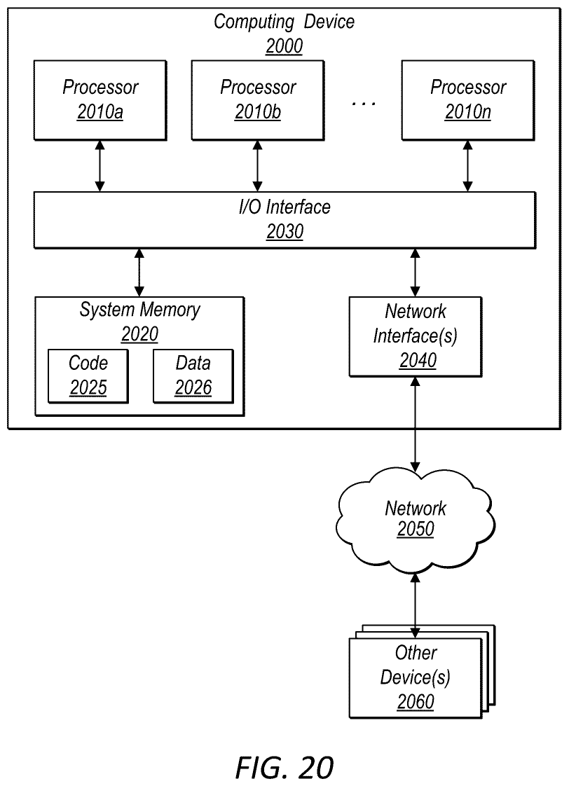

FIG. 20 is a block diagram illustrating an example computing device that may be used in at least some embodiments.

FIG. 20 illustrates such a general-purpose computing device 2000 as may be used in any of the embodiments described herein. In the illustrated embodiment, computing device 2000 includes one or more processors 2010 coupled to a system memory 2020 (which may comprise both non-volatile and volatile memory modules) via an input/output (I/O) interface 2030. Computing device 2000 further includes a network interface 2040 coupled to I/O interface 2030.

In various embodiments, computing device 2000 may be a uniprocessor system including one processor 2010, or a multiprocessor system including several processors 2010 (e.g., two, four, eight, or another suitable number). Processors 2010 may be any suitable processors capable of executing instructions. For example, in various embodiments, processors 2010 may be general-purpose or embedded processors implementing any of a variety of instruction set architectures (ISAs), such as the x86, PowerPC, SPARC, or MIPS ISAs, or any other suitable ISA. In multiprocessor systems, each of processors 2010 may commonly, but not necessarily, implement the same ISA. In some implementations, graphics processing units (GPUs) may be used instead of, or in addition to, conventional processors. In some embodiments, the processors 2010 may include a field programmable gate array (FPGA) that acts as an interface to a QPU, wherein the FPGA executes a compiled artifact to cause instruments of the QPU to emit pulses according to a pulse sequence indicated in the compiled artifact.

System memory 2020 may be configured to store instructions and data accessible by processor(s) 2010. In at least some embodiments, the system memory 2020 may comprise both volatile and non-volatile portions; in other embodiments, only volatile memory may be used. In various embodiments, the volatile portion of system memory 2020 may be implemented using any suitable memory technology, such as static random-access memory (SRAM), synchronous dynamic RAM or any other type of memory. For the non-volatile portion of system memory (which may comprise one or more NVDIMMs, for example), in some embodiments flash-based memory devices, including NAND-flash devices, may be used. In at least some embodiments, the non-volatile portion of the system memory may include a power source, such as a supercapacitor or other power storage device (e.g., a battery). In various embodiments, memristor based resistive 2random-access memory (ReRAM), three-dimensional NAND technologies, Ferroelectric RAM, magnetoresistive RAM (MRAM), or any of various types of phase change memory (PCM) may be used at least for the non-volatile portion of system memory. In the illustrated embodiment, program instructions and data implementing one or more desired functions, such as those methods, techniques, and data described above, are shown stored within system memory 2020 as code 2025 and data 2026.

In some embodiments, I/O interface 2030 may be configured to coordinate I/O traffic between processor 2010, system memory 2020, and any peripheral devices in the device, including network interface 2040 or other peripheral interfaces such as various types of persistent and/or volatile storage devices. In some embodiments, I/O interface 2030 may perform any necessary protocol, timing or other data transformations to convert data signals from one component (e.g., system memory 2020) into a format suitable for use by another component (e.g., processor 2010). In some embodiments, I/O interface 2030 may include support for devices attached through various types of peripheral buses, such as a variant of the Peripheral Component Interconnect (PCI) bus standard or the Universal Serial Bus (USB) standard, for example. In some embodiments, the function of I/O interface 2030 may be split into two or more separate components, such as a north bridge and a south bridge, for example. Also, in some embodiments some or all of the functionality of I/O interface 2030, such as an interface to system memory 2020, may be incorporated directly into processor 2010.

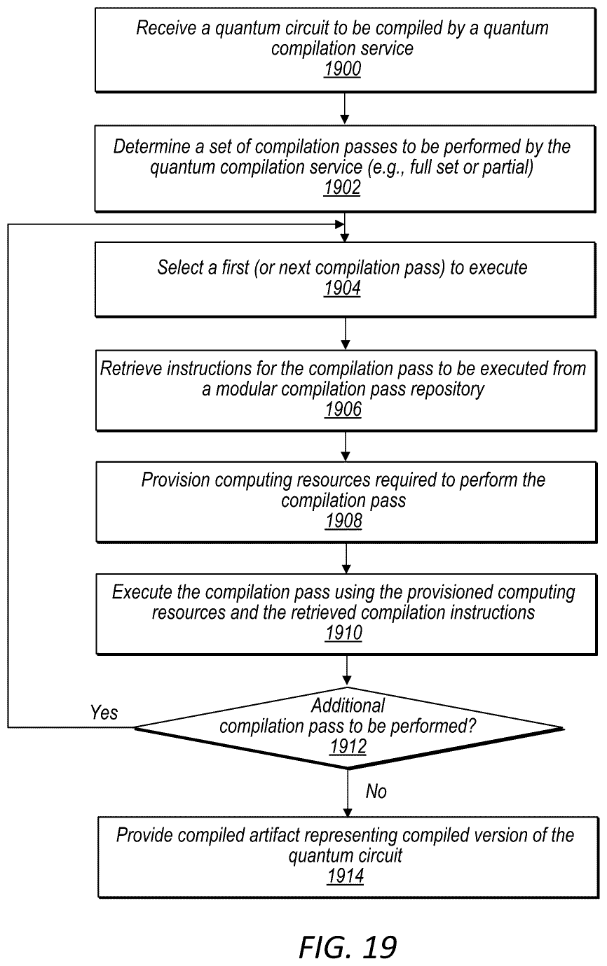

Network interface 2040 may be configured to allow data to be exchanged between computing device 2000 and other devices 2060 attached to a network or networks 2050, such as other computer systems or devices as illustrated in FIG. 1 through FIG. 19, for example. In various embodiments, network interface 2040 may support communication via any suitable wired or wireless general data networks, such as types of Ethernet network, for example. Additionally, network interface 2040 may support communication via telecommunications/telephony networks such as analog voice networks or digital fiber communications networks, via storage area networks such as Fibre Channel SANs, or via any other suitable type of network and/or protocol.

In some embodiments, system memory 2020 may represent one embodiment of a computer-accessible medium configured to store at least a subset of program instructions and data used for implementing the methods and apparatus discussed in the context of FIG. 1 through FIG. 19. However, in other embodiments, program instructions and/or data may be received, sent or stored upon different types of computer-accessible media. Generally speaking, a computer-accessible medium may include non-transitory storage media or memory media such as magnetic or optical media, e.g., disk or DVD/CD coupled to computing device 2000 via I/O interface 2030. A non-transitory computer-accessible storage medium may also include any volatile or non-volatile media such as RAM (e.g., SDRAM, DDR SDRAM, RDRAM, SRAM, etc.), ROM, etc., that may be included in some embodiments of computing device 2000 as system memory 2020 or another type of memory. In some embodiments, a plurality of non-transitory computer-readable storage media may collectively store program instructions that when executed on or across one or more processors implement at least a subset of the methods and techniques described above. A computer-accessible medium may further include transmission media or signals such as electrical, electromagnetic, or digital signals, conveyed via a communication medium such as a network and/or a wireless link, such as may be implemented via network interface 2040. Portions or all of multiple computing devices such as that illustrated in FIG. may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computing device”, as used herein, refers to at least all these types of devices, and is not limited to these types of devices.

### CONCLUSION

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g., SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent exemplary embodiments of methods. The methods may be implemented in software, hardware, or a combination thereof. The order of method may be changed, and various elements may be added, reordered, combined, omitted, modified, etc.

Various modifications and changes may be made as would be obvious to a person skilled in the art having the benefit of this disclosure. It is intended to embrace all such modifications and changes and, accordingly, the above description to be regarded in an illustrative rather than a restrictive sense.

What is claimed is:

1. A system, comprising:
one or more computing devices of a service provider network configured to implement a quantum compilation service, wherein to implement the quantum compilation service, the one or more computing devices are configured to:
receive a quantum circuit to be compiled, wherein the quantum circuit is represented in an intermediate representation;
determine a set of compilation passes to be performed for at least a portion of a compilation process for compiling the received quantum circuit, based on a given quantum processing unit to be used to execute the quantum circuit, wherein the quantum compilation service supports compiling quantum circuits for quantum processing units implemented using a plurality of quantum computing technologies;
for each compilation pass of the set of compilation passes:
access a modular compilation pass repository to retrieve instructions for performing the respective compilation pass;
provision computing resources required to perform the respective compilation pass; and
execute the instructions for performing the respective compilation pass using the provisioned computing resources; and
provide a compiled artifact representing a compiled version of the quantum circuit,
wherein the compilation service is configured to perform compilation for a plurality of customers of the service provider network as a compilation-as-a-service resource of the service provider network.

2. The system of claim 1, wherein the set of compilation passes comprises a full set of compilation passes for compiling the received quantum circuit.

3. The system of claim 2, wherein the one or more computing devices are further configured to:
provide the compiled artifact representing the compiled version of the quantum circuit to a quantum computing service of the service provider network, wherein the quantum computing service is configured to cause the compiled version of the quantum circuit to be executed on a quantum hardware provider quantum processing unit (QPU) or on a quantum processing unit of the service provider network.

4. The system of claim 1, wherein the set of compilation passes performed by the quantum compilation service comprises a first portion of a full set of compilation passes for compiling the received quantum circuit, wherein the one or more computing devices are further configured to:
provide a partially compiled version of the quantum circuit, represented in an intermediate representation, to a customer of the service provider network;
receive, a further partially compiled version of the quantum circuit, represented in the intermediate representation, wherein the customer has caused a second set of one or more compilation passes to be performed for compiling the received quantum circuit;
wherein the compiled artifact representing the compiled version of the quantum circuit is generated using the further partially compiled version of the quantum circuit represented in the intermediate representation that is received from the customer of the service provider network.

5. The system of claim 4, wherein the or more computing devices are configured to:
perform one or more remaining compilation passes of the set of compilation passes using the further partially compiled version of the quantum circuit, represented in the intermediate representation, as an input to the one or more remaining compilation passes.

6. The system of claim 1, further comprising:
one or more additional computing devices configured to implement a quantum computing service, wherein to implement the quantum computing service, the one or more additional computing devices are configured to:
receive a quantum circuit for execution by the quantum computing service;
cause the compilation service to compile the quantum circuit into a compiled artifact for execution on a particular quantum processing unit (QPU); and
orchestrate execute of the quantum circuit on the QPU using the compiled binary.

7. The system of claim 1, wherein the compiled artifact representing the compiled version of the quantum circuit is a pulse-level compiled binary comprising instructions, that when executed by a field programming gate array or processor, cause pulses to be directed at a quantum hardware device to execute the quantum circuit.

8. The system of claim 7, wherein the or more computing devices are configured to:
receive one or more custom pulse sequences to be used to implement one or more respective gates of the quantum circuit being compiled, wherein the pulse-level compiled binary comprises one or more of the custom pulse sequences.

9. The system of claim 1, wherein the compiled artifact representing the compiled version of the quantum circuit is a native-gate level representation of the quantum circuit comprising native gates that are native to a given quantum processing unit that is to be used to execute the quantum circuit.

10. The system of claim 7, wherein:
the quantum circuit to be compiled is received in a first request indicating a verbatim compilation is be performed, and
the or more computing devices are configured to:
store the compiled artifact representing the compiled version of the quantum circuit; and
for one or more subsequent requests to compile the quantum circuit using the verbatim compilation, provide, in response to the one or more subsequent requests, the stored compiled artifact in a same format and comprising same contents as was provided for the first request.

11. The system of claim 1, further comprising:
one or more computing devices configured to implement a quantum device information service configured to:
receive information about quantum processing units of quantum hardware providers; and
provide the received information to the quantum compilation service for use in compiling quantum circuits to be executed on the quantum processing units of the quantum hardware providers.

12. A method, comprising:
receiving, at a quantum compilation service, a quantum circuit to be compiled;
provisioning, by the quantum compilation service, computing resources to perform a plurality of compilation passes to compile the received quantum circuit;
orchestrating, by the quantum compilation service, performance of the respective compilation passes using the provisioned computing resources; and
providing a compiled artifact representing a compiled version of the quantum circuit,
wherein the compilation service is configured to perform compilation for quantum circuits received from a plurality of customers as a compilation-as-a-service resource.

13. The method of claim 12, wherein the plurality of compilation passes comprise modular compilation passes selected from a modular compilation pass repository of the quantum compilation service.

14. The method of claim 13, wherein the compilation pass repository of the quantum compilation service comprises:
a plurality of qubit allocation and gate mapping compilation passes; and
a plurality of pulse-level compilation passes.

15. The method of claim 14, wherein the plurality of qubit allocation and gate mapping compilation passes comprise two or more of:
a SAT solving-based gate scheduling and mapping compilation pass;
an SMT solving-based gate scheduling and mapping compilation pass; or
a reinforcement-learning model-based gate scheduling and mapping compilation pass.

16. The method of claim 15, further comprising:
scaling up or down, by the quantum compilation service, a quantity of computing resources provisioned to perform a given qubit gate mapping compilation pass, wherein the quantity of computing resources is scaled such that the gate mapping compilation pass completes within a threshold amount of time or with less than a threshold amount of cost incurred to perform the quit gate mapping compilation pass.

17. The method of claim 12, further comprising:
determining, by the quantum compilation service, a set of compilation passes to be performed for at least a portion of a compilation process for compiling the received quantum circuit,
wherein said orchestrating performance of the respective compilation passes, comprises:
accessing a modular compilation pass repository to retrieve instructions for performing the respective compilation passes; and
executing the instructions for performing the respective compilation passes using the provisioned computing resources.

18. The method of claim 13, further comprising:
receiving, from a customer of the quantum compilation service, a custom compilation pass; and
adding the custom compilation pass to the modular compilation pass repository for use in compiling quantum circuits of the customer.

19. One or more non-transitory, computer-readable, storage media storing program instructions that, when executed on or across one or more processors, cause the one or more processors to implement a quantum compilation service configured to:
cause computing resources to be provisioned to perform a plurality of compilation passes to compile a received quantum circuit;
orchestrate performance of the respective compilation passes using the provisioned computing resources; and
provide a compiled artifact representing a compiled version of the quantum circuit,
wherein the compilation service is configured to perform compilation for a plurality of customers as a compilation-as-a-service resource.

20. The one or more non-transitory, computer-readable storage media of claim 19, wherein the program instructions, when executed on or across the one or more processors, cause the one or more processors to:
receive a first request indicating a verbatim compilation is be performed for the quantum circuit;
cause the compiled artifact representing the compiled version of the quantum circuit to be stored; and
provide, for one or more subsequently received requests to compile the quantum circuit using the verbatim compilation, the stored compiled artifact.
